(19) United States
(12) Patent Application Publication
(10) Pub. No.: US 2009/0146984 A1
(43) Pub. Date: Jun. 11, 2009

(54) PLASMA DISPLAY APPARATUS

(75) Inventors: Jong Woon BAE, Gumi-si (KR); Ki Rack PARK, Gumi-si (KR); Seong Hwan RYU, Gumi-si (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/329,152

(22) Filed: Dec. 5, 2008

(30) Foreign Application Priority Data
Dec. 7, 2007 (KR) 10-2007-0126825

(51) Int. Cl. G09G 5/00; G09G 3/28

(52) U.S. Cl. 345/208; 345/60

(57) ABSTRACT

The present invention relates to a plasma display apparatus. The plasma display apparatus of the present invention includes a plasma display panel having a plurality of scan electrodes and a sustain electrode formed in a front substrate, and drivers supplying driving signals to the plurality of electrodes. The plurality of scan electrodes is divided into two or more groups, each comprising first and second groups. In a reset period of at least one of a plurality of subfields constituting one frame, during a set-up period, voltages supplied to scan electrodes of at least one of the first and second groups gradually rise from a first voltage to a second voltage, and a voltage supplied to the sustain electrode gradually rises from a third voltage to a fourth voltage. In accordance with the plasma display apparatus according to the present invention, in driving a high-resolution plasma display panel such as Full HD panels, reset signals that gradually rise and fall are supplied to the scan electrodes and the sustain electrodes at the same time. Accordingly, an erroneous discharge in an address period can be reduced, and the picture quality of a display image can be improved.

### CROSS-REFERENCE TO RELATED APPLICATION

This application claims under 35 U.S.C. §119(a) the benefit of Korean Patent Application No. 10-2007-0126825 filed Dec. 7, 2007, the entire contents of which are incorporated herein by reference.

### BACKGROUND OF THE INVENTION

1. Field of the Invention

The present invention relates to a plasma display apparatus and, more particularly, to an apparatus for driving a plasma display panel.

2. Description of the Conventional Art

A plasma display apparatus includes a panel in which a plurality of discharge cells is formed between a rear substrate, having barrier ribs formed therein, and a front substrate. The plasma display apparatus is an apparatus displaying an image by emitting phosphors with vacuum ultraviolet rays, which are generated by selectively discharging the plurality of discharge cells according to input picture signals.

In order to display an image effectively, the plasma display apparatus generally includes a driving controller, which processes input picture signals and outputs the processed signals to a driver for supplying driving signals to the plurality of electrodes included in the panel.

In the case of a plasma display apparatus having a large-sized screen, it is necessary to drive the panel stably at high speed because time margin for driving the panel is short.

### SUMMARY OF THE INVENTION

It is, therefore, an object of the present invention to provide a plasma display apparatus, which is capable of improving an erroneous address discharge in driving a plasma display panel with a high resolution.

In accordance with an embodiment of the present invention, there is provided a plasma display apparatus, including a plasma display panel having a plurality of scan electrodes and a sustain electrode formed in a front substrate, and drivers supplying driving signals to the plurality of electrodes. The plurality of scan electrodes is divided into two or more groups, each comprising first and second groups. In a reset period of at least one of a plurality of subfields constituting one frame, during a set-up period, voltages supplied to scan electrodes of at least one of the first and second groups gradually rise from a first voltage to a second voltage, and a voltage supplied to the sustain electrode gradually rises from a third voltage to a fourth voltage.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view showing an embodiment with respect to the structure of a plasma display panel according to the present invention;

FIG. 2 is a diagram showing an embodiment with respect to the arrangement of electrodes of the plasma display panel;

FIG. 3 is a timing diagram showing an embodiment with respect to a method of dividing one frame into a plurality of subfields and driving a plasma display panel in a time-divided manner;

FIG. 4 is a timing diagram showing an embodiment with respect to waveforms of driving signals for driving the plasma display panel;

FIGS. 5 to 17 are timing diagrams showing embodiments with respect to driving signal waveforms of the panel according to the present invention;

FIGS. 18 and 19 are sectional views showing embodiments with respect to the structure of a front substrate of the plasma display panel;

FIGS. 20 and 21 are sectional views showing embodiments with respect to the structure of a rear substrate of the plasma display panel;

FIG. 22 is a diagram schematically showing the arrangement of electrode drivers of the plasma display panel according to an embodiment of the present invention; and

FIGS. 23 to 27 are timing diagrams showing embodiments with respect to driving signal waveforms of the panel according to the present invention.

### DETAILED DESCRIPTION OF THE EMBODIMENTS

Hereinafter, embodiments of the present invention will be described in detail with reference to the accompanying drawings so that they can be readily implemented by those skilled in the art.

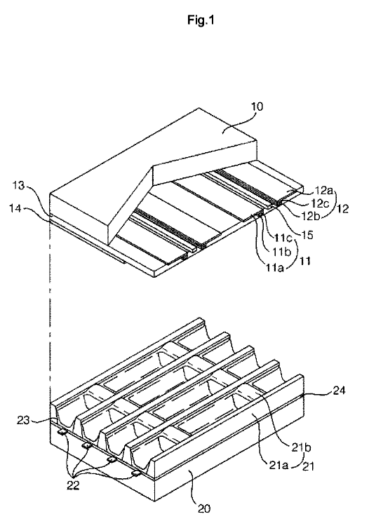

A plasma display apparatus according to the present invention will now be described in detail with reference to the accompanying drawings. FIG. 1 is a perspective view showing an embodiment with respect to the structure of a plasma display panel according to the present invention.

Hereinafter, a method of driving a plasma display panel and a plasma display apparatus employing the same according to the preset invention will be described in detail with reference to the accompanying drawings. FIG. 1 is a perspective view showing an embodiment with respect to the structure of a plasma display panel according to the present invention.

As shown in FIG. 1, the plasma display panel includes scan electrodes 11 and sustain electrodes 12 (i.e., sustain electrode pairs), which are formed over a front substrate 10, and address electrodes 22 formed over a rear substrate 20.

Each sustain electrode pair 11 and 12 includes transparent electrodes 11a and 12a, generally formed from indium-tin-oxide (ITO), and bus electrodes 11b and 12b. The bus electrodes 11b and 12b may be formed from metal, such as silver (Ag) or chrome (Cr), a stack type of Cr/copper (Cu)/Cr or Cr/aluminum (Al)/Cr. The bus electrodes 11b and 12b are formed on the transparent electrodes 11a and 12a, and function to decrease a voltage drop caused by the transparent electrodes 11a and 12a with a high resistance.

Meanwhile, according to an embodiment of the present invention, the sustain electrode pair 11 and 12 may have a stack structure of the transparent electrodes 11a and 12a and the bus electrodes 11b and 12b, but also include only the bus electrodes 11b and 12b without the transparent electrodes 11a and 12a. This structure is advantageous in that it can save the manufacturing cost of the plasma display panel because the transparent electrodes 11a and 12a are not used. The bus electrodes 11b and 12b used in the structure may also be formed using a variety of materials, such as a photosensitive material, other than the above-listed materials.

Black matrices 15 are arranged between the transparent electrodes 11a and 12a and the bus electrodes 11b and 12b of the scan electrode 11 and the sustain electrode 12. The black matrix 15 has a light-shielding function of absorbing external light generated outside the front substrate 10 and decreasing reflection of the light and a function of improving the purity and contrast of the front substrate 10.

The black matrices 15 according to an embodiment of the present invention are formed over the front substrate 10. Each black matrix 15 may include a first black matrix 15 formed at a location where it is overlapped with a barrier rib 21, and second black matrices 11c and 12c formed between the transparent electrodes 11a and 12a and the bus electrodes 11b and 12b. The first black matrix 15, and the second black matrices 11c and 12c, which are also referred to as black layers or black electrode layers, may be formed at the same time and, therefore, may be connected physically. Alternatively, they may not be formed at the same time and, therefore, may not be connected physically.

Further, in the case in which the first black matrix 15 and the second black matrices 11c and 12c are connected to each other physically, the first black matrix 15 and the second black matrices 11c and 12c are formed using the same material. However, in the case in which the first black matrix 15 and the second black matrices 11c and 12c are physically separated from each other, they may be formed using different materials.

An upper dielectric layer 13 and a protection layer 14 are laminated over the front substrate 10 in which the scan electrodes 11 and the sustain electrodes 12 are formed in parallel. Charged particles generated by a discharge are accumulated on the upper dielectric layer 13. The upper dielectric layer 13 and the protection layer 14 may function to protect the sustain electrode pair 11 and 12. The protection layer 14 functions to protect the upper dielectric layer 13 from sputtering of charged particles generated at the time of a gas discharge and also increase emission efficiency of secondary electrons.

The address electrodes 22 cross the scan electrodes 11 and the sustain electrodes 12. A lower dielectric layer 24 and the barrier ribs 21 are formed over the rear substrate 20 over which the address electrodes 22 are formed.

Phosphor layers 23 are formed on the surfaces of the lower dielectric layer 24 and the barrier ribs 21. Each barrier rib 21 has a longitudinal barrier rib 21a and a traverse barrier rib 21b formed in a closed type. The barrier rib 21 functions to partition discharge cells physically and prevent ultraviolet rays, which are generated by a discharge, and a visible ray from leaking to neighboring discharge cells.

The embodiment of the present invention may also be applied to not only the structure of the barrier ribs 21 shown in FIG. 1, but also various forms of structures of the barrier ribs 21. For example, the present embodiment may be applied to a differential type barrier rib structure in which the longitudinal barrier rib 21a and the traverse barrier rib 21b have different heights, a channel type barrier rib structure in which a channel, which can be used as an exhaust passage, is formed in at least one of the longitudinal barrier rib 21a and the traverse barrier rib 21b, a hollow type barrier rib structure in which a hollow is formed in at least one of the longitudinal barrier rib 21a and the traverse barrier rib 21b, and so on.

In the differential type barrier rib structure, the traverse barrier rib 21b may preferably have a higher height than the longitudinal barrier rib 21a. In the channel type barrier rib structure or the hollow type barrier rib structure, a channel or hollow may be preferably formed in the traverse barrier rib 21b.

Meanwhile, in the present embodiment, it has been described and shown that the red (R), green (G), and blue (B) discharge cells are arranged on the same line. However, they may be arranged in different forms. For example, the R, G, and B discharge cells may also have a delta type arrangement of a triangle. Alternatively, the discharge cells may be arranged in various forms, such as square, pentagon and hexagon.

Furthermore, the phosphor layer 23 is excited with ultraviolet rays generated during the discharge of a gas, thus generating a visible ray of one of R, G, and B. Discharge spaces between the front/rear substrates 10 and 20 and the barrier ribs 21 are injected with an inert mixed gas for a discharge, such as He+Xe, Ne+Xe or He+Ne+Xe.

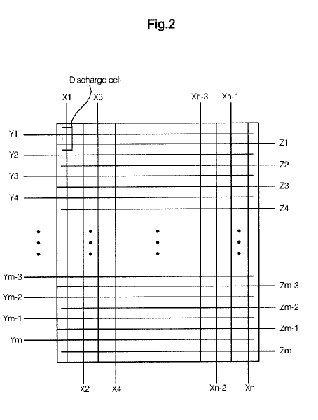

FIG. 2 is a diagram showing an embodiment with respect to the arrangement of electrodes of the plasma display panel. It may be preferred that a plurality of discharge cells constituting the plasma display panel be arranged in matrix form, as illustrated in FIG. 2. The plurality of discharge cells are disposed at the intersections of scan electrode lines Y1 to Ym, sustain electrodes lines Z1 to Zm, and address electrodes lines X1 to Xn, respectively. The scan electrode lines Y1 to Ym may be driven sequentially or at the same time. The sustain electrode lines Z1 to Zm may be driven at the same time. The address electrode lines X1 to Xn may be driven by dividing them into even-numbered lines and odd-numbered lines or driving them sequentially.

The electrode arrangement shown in FIG. 2 is only an embodiment with respect to the electrode arrangement of the plasma display panel according to the present invention. Accordingly, the present invention is not limited to the electrode arrangement and the method of driving the plasma display panel shown in FIG. 2. For example, the present invention may be applied to a dual scan method of driving two of the scan electrode lines Y1 to Ym at the same time. Alternatively, the address electrode lines X1 to Xn may be driven by dividing them into upper and lower parts on the basis of the center of the plasma display panel.

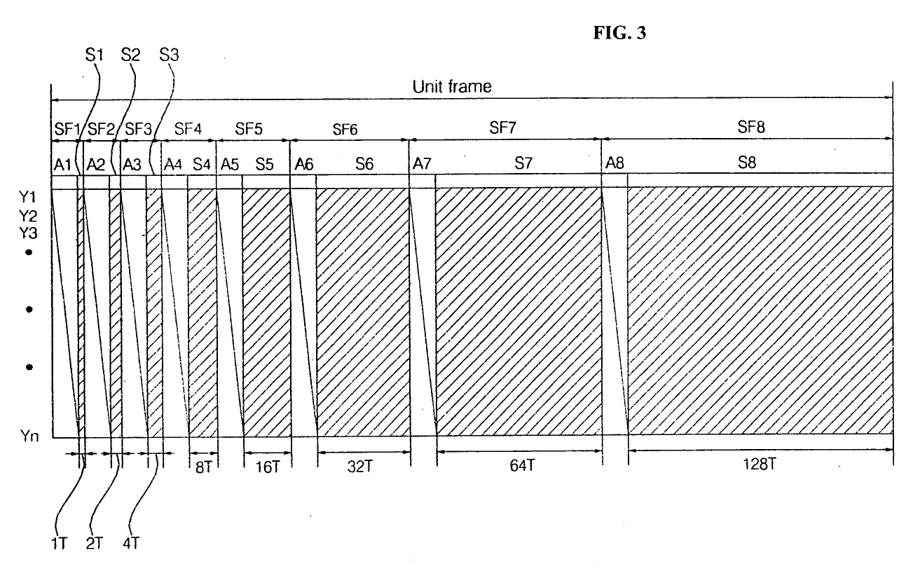

FIG. 3 is a timing diagram showing an embodiment with respect to a method of dividing one frame into a plurality of subfields and driving a plasma display panel in a time-divided manner. A unit frame may be divided into a predetermined number (for example, eight) of subfields SF1, . . . , SF8 in order to realize a time dividing gray level display. Each of the subfields SF1, . . . , SF8 is divided into a reset period (not shown), address periods A1, . . . , A8, and sustain periods S1, . . . , S8.

According to an embodiment of the present invention, the reset period may be omitted in at least one of the plurality of subfields. For example, the reset period may exist only in the first subfield, or exist only in a subfield approximately between the first subfield and the entire subfields.

In each of the address periods A1, . . . , A8, a display data signal is applied to the address electrode X, and scan signals corresponding to the scan electrodes Y are sequentially applied to the address electrode X.

In each of the sustain periods S1, . . . , S8, a sustain pulse is alternately applied to the scan electrodes Y and the sustain electrodes Z. Accordingly, a sustain discharge is generated in discharge cells on which wall charges are formed in the address periods A1, . . . , A8.

The luminance of the plasma display panel is proportional to the number of sustain discharge pulses within the sustain periods S1, . . . , S8, which is occupied in a unit frame. In the case in which one frame to form 1 image is represented by eight subfields and 256 gray levels, different numbers of sustain pulses may be sequentially allocated to the respective subfields at a ratio of 1, 2, 4, 8, 16, 32, 64, and 128. For example, in order to obtain the luminance of 133 gray levels, a sustain discharge can be generated by addressing the cells during the subfield1 period, the subfield3 period, and the subfield8 period.

The number of sustain discharges allocated to each subfield may be varied depending on the weight of a subfield according to an automatic power control (APC) step. In other words, although an example in which one frame is divided into eight subfields has been described with reference to FIG. 3, the present invention is not limited to the above example, but the number of subfields to form one frame may be changed in various ways depending on design specifications. For example, the plasma display panel may be driven by dividing one frame into eight or more subfields, such as 12 or 16 subfields.

Further, the number of sustain discharges allocated to each subfield may be changed in various ways in consideration of gamma characteristics or panel characteristics. For example, the degree of gray levels allocated to the subfield4 may be lowered from 8 to 6, and the degree of gray levels allocated to the subfield6 may be raised from 32 to 34.

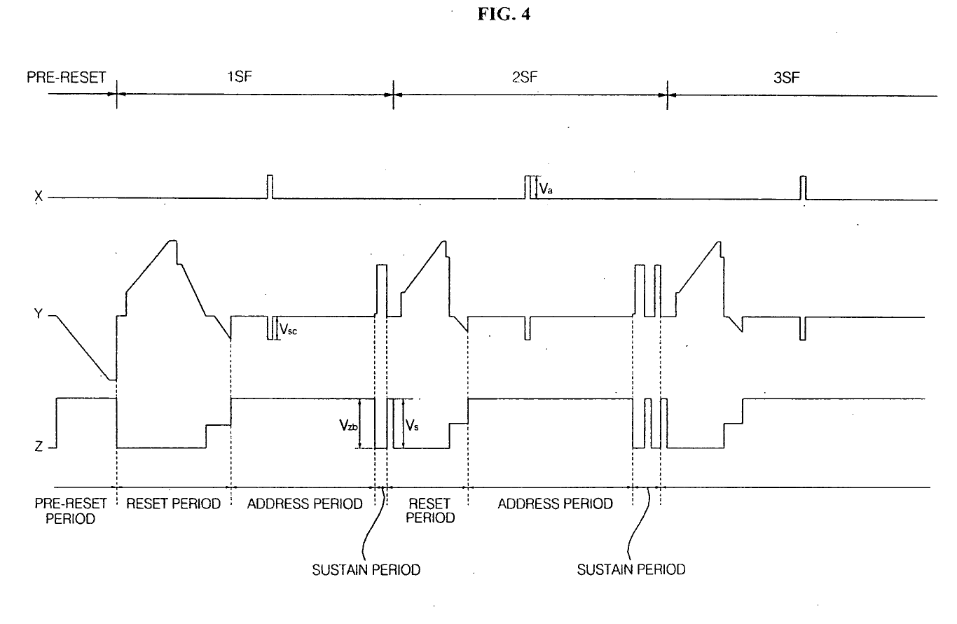

FIG. 4 is a timing diagram showing an embodiment with respect to waveforms of driving signals for driving the plasma display panel.

Each subfield includes a pre-reset period where positive wall charges are formed on the scan electrodes Y and negative wall charges are formed on the sustain electrodes Z, a reset period where discharge cells of the entire screen are reset using wall charge distributions formed in the pre-reset period, an address period where discharge cells are selected, and a sustain period where the discharge of selected discharge cells is sustained.

The reset period includes a set-up period and a set-down period. In the set-up period, a ramp-up waveform is applied to the entire scan electrodes at the same time, so that a minute discharge occurs in the entire discharge cells and wall charges are generated accordingly. In the set-down period, a ramp-down waveform, which falls from a positive voltage lower than a peak voltage of the ramp-up waveform, is applied to the entire scan electrodes Y at the same time, so that an erase discharge occurs in the entire discharge cells. Accordingly, unnecessary charges are erased from the wall charges generated by the set-up discharge and spatial charges.

In the address period, scan signals, each having scan voltages (Vsc) of negative polarity, are sequentially applied to the scan electrodes Y and, at the same time, data signals of positive polarity are applied to the address electrodes X. Address discharge is generated by a voltage difference between the scan signal and the data signal and a wall voltage generated during the reset period, so the cells are selected. Meanwhile, in order to enhance the efficiency of the address discharge, a sustain bias voltage (Vzb) is applied to the sustain electrode during the address period.

During the address period, the plurality of scan electrodes Y may be divided into two or more groups and sequentially supplied with the scan signals on a group basis. Each of the divided groups may be divided into two or more subgroups and sequentially supplied with the scan signals on a subgroup basis. For example, the plurality of scan electrodes Y may be divided into a first group and a second group. For example, the scan signals may be sequentially supplied to the scan electrodes belong to the first group, and then sequentially supplied to the scan electrodes belong to the second group.

In an embodiment of the present invention, the plurality of scan electrodes Y may be divided into a first group, located at an even-numbered position, and a second group, located at an odd-numbered position, depending upon positions where the electrodes are formed on the panel. In another embodiment, the plurality of scan electrodes Y may be divided into a first group, disposed on an upper side, and a second group, disposed on a lower side, on the basis of the center of the panel.

The scan electrodes, which belong to the first group divided according to the above method, may be divided into a first subgroup located at an even-numbered position and a second subgroup located at an odd-numbered position, or a first subgroup disposed on an upper side and a second subgroup disposed on a lower side on the basis of the center of the first group.

In the sustain period, a sustain pulse having a sustain voltage (Vs) is alternately applied to the scan electrodes and the sustain electrodes, so a sustain discharge is generated between the scan electrodes and the sustain electrodes in a surface discharge fashion.

The width of a first sustain signal or a last sustain signal, of the plurality of sustain signals, which are alternately applied to the scan electrodes and the sustain electrodes in the sustain period, may be greater than that of the remaining sustain pulses.

After the sustain discharge is generated, an erase period in which wall charges remaining in scan electrodes or sustain electrodes of an on-cell selected in the address period are erased by generating a weak discharge may be further included posterior to the sustain period.

The erase period may be included in all the plurality of subfields or some of the plurality of subfields. In this erase period, it may be preferred that an erase signal for the weak discharge may be applied to electrodes to which the last sustain pulse was not applied in the sustain period.

The erase signal may include a ramp form signal that gradually rises, a low-voltage wide pulse, a high-voltage narrow pulse, an exponential signal, a half-sinusoidal pulse or the like.

In addition, in order to generate the weak discharge, a plurality of pulses may be applied to the scan electrodes or the sustain electrodes sequentially.

The driving waveforms shown in FIG. 4 illustrate embodiments with respect to signals for driving the plasma display panel according to the present invention. However, the present invention is not limited to the waveforms shown in FIG. 4. For instance, the pre-reset period may be omitted, the polarities and voltage levels of the driving signals shown in FIG. 4 may be changed according to conditions, and an erase signal for erasing wall charges may be applied to the sustain electrodes after the sustain discharge is completed. Alternatively, a single sustain driving method of generating a sustain discharge by applying the sustain signal to either the scan electrodes Y or the sustain electrodes Z is also possible.

In the case of a panel with a high resolution, a distance between two neighboring scan electrodes is narrowed as the number of the scan electrode lines increases. Accordingly, a possibility that an erroneous discharge may happen due to cross talk between the electrodes may rise. Further, since the length of the address period may not be increased to a specific value or more in order to secure panel driving margin, widths of the scan signals sequentially supplied to the increased scan electrode lines inevitably decrease, thereby further increasing a possibility that an erroneous address discharge may be generated.

For example, in the case of a Full HD panel, the number of the scan electrode lines is 1080 or more, and the length of the address period may be about 16.67 ms in order to secure panel driving margin. In this case, when considering the number of the scan electrode lines and the length of the address period, the width of the scan signal must be 1.5 μs or less.

In the case in which, in order to drive a panel in which the number of the scan electrode lines is 1080 or more such as Full HD panels, the width of the scan signal is set to 1.5 μs or less, a possibility that an erroneous address discharge may happen may rise significantly according to a reduction in the address discharge efficiency.

Accordingly, in order to stably drive a high-resolution plasma display panel in which the number of the scan electrode lines is 1080 or more, it is very important to improve the discharge efficiency of the panel, in particular, an address discharge delay phenomenon by improving the jitter characteristic of the panel, which is related to an address discharge.

In the case of the plasma display apparatus according to the present invention, an erroneous discharge that may be generated during the address period can be reduced by supplying a waveform similar to the reset signal, which is supplied to the scan electrodes during the reset period, for example, a signal having a gradually rising voltage to the sustain electrodes. Further, driving timing margin can be secured and a stable discharge can also be performed, by dividing the scan electrodes into a plurality of groups and driving the divided electrodes and supplying a signal having a gradually rising voltage to at least one group during a reset period.

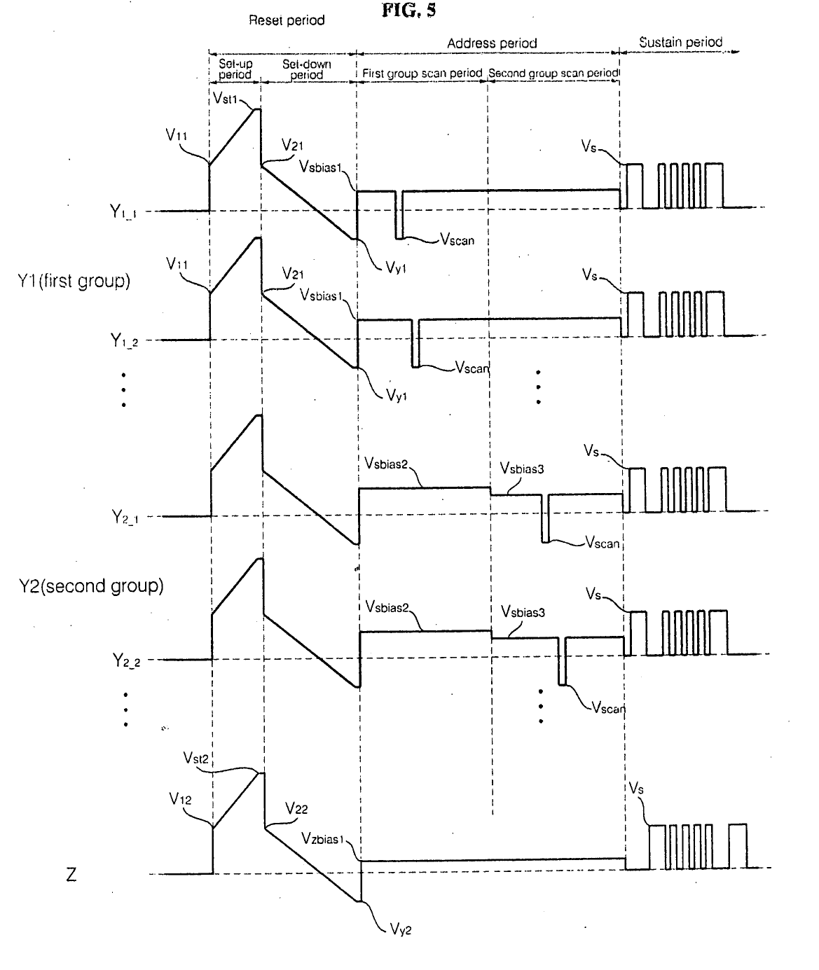

FIGS. 5 to 17 are timing diagrams showing embodiments with respect to driving signal waveforms of the panel according to the present invention.

In the plasma display apparatus according to the present invention, during a set-up period of a reset period of at least one of a plurality of subfields constituting one frame, voltage applied to the scan electrodes of at least one of the first and second groups gradually rises from a first voltage to a second voltage, and voltage applied to the sustain electrodes gradually rises from a third voltage to a fourth voltage.

Referring to FIG. 5, the plurality of scan electrodes Y formed in the panel may be divided into at least two groups Y1 and Y2. An address period may be divided into first and second group scan periods in which scan signals are supplied to the divided first and second groups, respectively. After the scan signals are sequentially supplied to the scan electrodes Y1 belonging to the first group during the first group scan period, the scan signals may be sequentially supplied to the scan electrodes Y2 belonging to the second group during the second group scan period.

For example, the plurality of scan electrodes Y may be divided into the first group Y1, located at an even-numbered position, and the second group Y2, located at an odd-numbered position, from an upper end of the panel according to positions where the groups are formed on the panel. As another embodiment, the plurality of scan electrodes Y may be divided into the first group Y1, located on an upper side, and the second group Y1, located on a lower side, on the basis of the center of the panel. The plurality of scan electrodes Y may be divided using another methods other than the above method, and the number of the scan electrodes belonging to the first and second groups Y1 and Y2, respectively, may differ.

During the reset period, negative charges of negative polarity are formed in the scan electrodes Y for the purpose of an address discharge. During the address period, driving signals supplied to the scan electrodes Y are sustained to a scan bias voltage, and scan signals of negative polarity are then sequentially supplied to the scan electrodes Y, so an address discharge is generated.

Referring to FIG. 5, during the set-up period of the reset period, first set-up signals each of which gradually rises from a V11 voltage to a Vst1 voltage may be supplied to the scan electrodes Y1 of the first group, and a second set-up signal, gradually rising from a V12 voltage to a Vst2 voltage, may be supplied to the sustain electrode Z.

As described above, in the case in which, in order to drive a panel in which the number of the scan electrode lines is 1080 or more, such as Full HD panels, the width of the scan signal is set to 1.5 μs or less, a possibility that an erroneous address discharge may be generated may rise significantly according to a reduction in the address discharge efficiency.

Since the first and second set-up signals that gradually rise are supplied to the scan electrodes Y1 of the first group and the sustain electrodes Z during the set-up period, a difference in the amount of wall charges, which are formed in the scan electrodes Y1 of the first group and the sustain electrodes Z during the set-up period, can be reduced. Accordingly, an erroneous discharge that may occur between the scan electrodes Y and the sustain electrodes Z during the address period can be reduced, and the discharge efficiency between the scan electrodes Y and the address electrodes X can be improved.

For example, the V11 voltage and the V12 voltage may be identical, and the Vst1 voltage and the voltage Vst2 may be identical. Accordingly, a rising slope of a first set-up signal may be identical to that of a second set-up signal. In this case, the potential between the scan electrodes Y1 of the first group and the address electrodes X becomes identical to that between the sustain electrodes Z and the address electrodes X, and the amount of wall charges formed in the scan electrodes Y and the amount of wall charges formed in the sustain electrodes Z, during the set-up period, may almost become similar to each other. Accordingly, even in the case in which a panel is driven under high temperature environment of 50 degrees Celsius or more, an erroneous address discharge depending on a shift in wall charges, etc. can be prevented.

In the case in which the plurality of scan electrodes Y is divided into the first and second groups and then sequentially supplied with the scan signals, wall charges of negative (−) polarity, which have been formed in the scan electrodes Y2 belonging to the second group Y2, may be lost during the first group scan period in which the scan signals are supplied to the first group Y1. Accordingly, there may be generated an erroneous address discharge in which an address discharge is not generated although the scan signals are supplied to the scan electrodes Y2 belonging to the second group Y2 during the second group scan period.

Accordingly, in order to reduce the loss in the negative (−) wall charges formed in the scan electrodes belonging to the second group Y2, a scan bias voltage (Vsbias2) supplied to the second group Y2 may be increased from the reset period until the second group scan period in which the scan signals are supplied to the second group Y2, for example, during the first group scan period, as shown in FIG. 5.

In other words, in order to reduce an erroneous address discharge, the scan bias voltage (Vsbias2), which is greater than a scan bias voltage (Vsbias1) supplied to the first group scan electrodes Y1, may be supplied to the second group scan electrodes Y2 during the first group scan period.

Referring to FIG. 5, the scan bias voltage supplied to the second group scan electrodes Y2 during the address period may vary. More specifically, the scan bias voltage (Vsbias2), which is supplied to the second group scan electrodes Y2 during the first group scan period of the address period, may be greater than a scan bias voltage (Vsbias3), which is supplied to the second group scan electrodes Y2 during the second group scan period.

In the case in which the plurality of scan electrodes is divided into the first group Y1 located at an even-numbered position and the second group Y2 located at an odd-numbered position, different scan bias voltages are supplied to the first and second group scan electrodes Y1 and Y2 during the first group scan period as described above. Accordingly, influence depending on interference between neighboring discharge cells can be reduced.

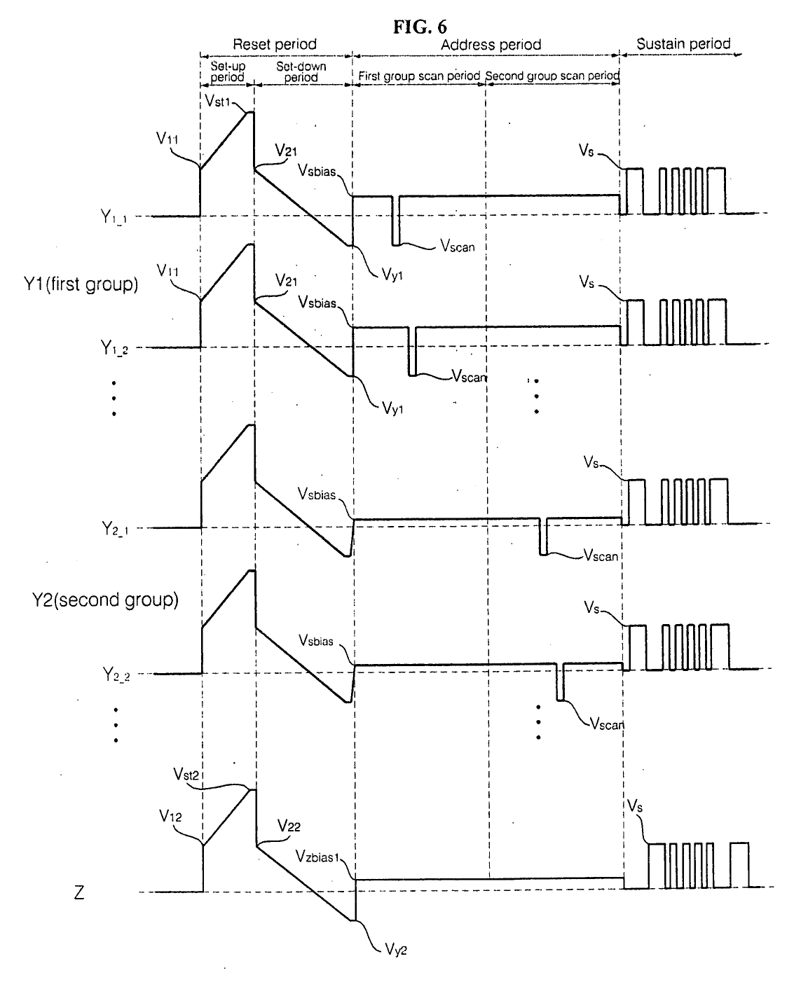

As in FIG. 6, bias voltages applied to the scan electrodes Y2 of the second group during the address period may have the same value by taking the easiness of a circuit operation and configuration into consideration. Further, reset signal waveforms of the first and second groups may be configured to be different.

The following Table 1 lists measurement results depending on whether an erroneous discharge was generated according to the width of the scan signal in the case in which a Full HD panel is driven using the driving signals of the waveforms as shown in FIG. 5.

TABLE 1

| Width (μs) of | Whether erroneous |
|---|---|
| scan signal | discharge occurred |
| 0.5 | ◯ |
| 0.55 | ◯ |
| 0.6 | ◯ |
| 0.65 | ◯ |
| 0.7 | X |
| 0.75 | X |
| 0.8 | X |
| 0.85 | X |
| 0.9 | X |
| 0.95 | X |
| 1 | X |
| 1.05 | X |
| 1.1 | X |
| 1.15 | ◯ |
| 1.2 | ◯ |
| 1.25 | ◯ |
| 1.3 | ◯ |
| 1.35 | ◯ |
| 1.4 | ◯ |
| 1.45 | ◯ |

Referring to Table 1, in the case in which the width of the scan signal is 0.65 μs or less, an erroneous discharge may be generated because a sufficient time to generate an address discharge is not secured. Accordingly, in order to generate an address discharge stably, it may be preferred that the width of the scan signal is 0.7 μs or more.

However, in the case in which the width of the scan signal exceeds 1.1 μs, an erroneous address discharge may be generated due to an effect between neighboring scan electrode lines because a distance between consecutively supplied scan signals is narrowed.

Accordingly, in order to secure a sufficient time for the occurrence of an address discharge and also prevent an erroneous address discharge by minimizing influence between neighboring scan electrode lines, the width of the scan signal may range from 0.7 μs to 1.1 μs.

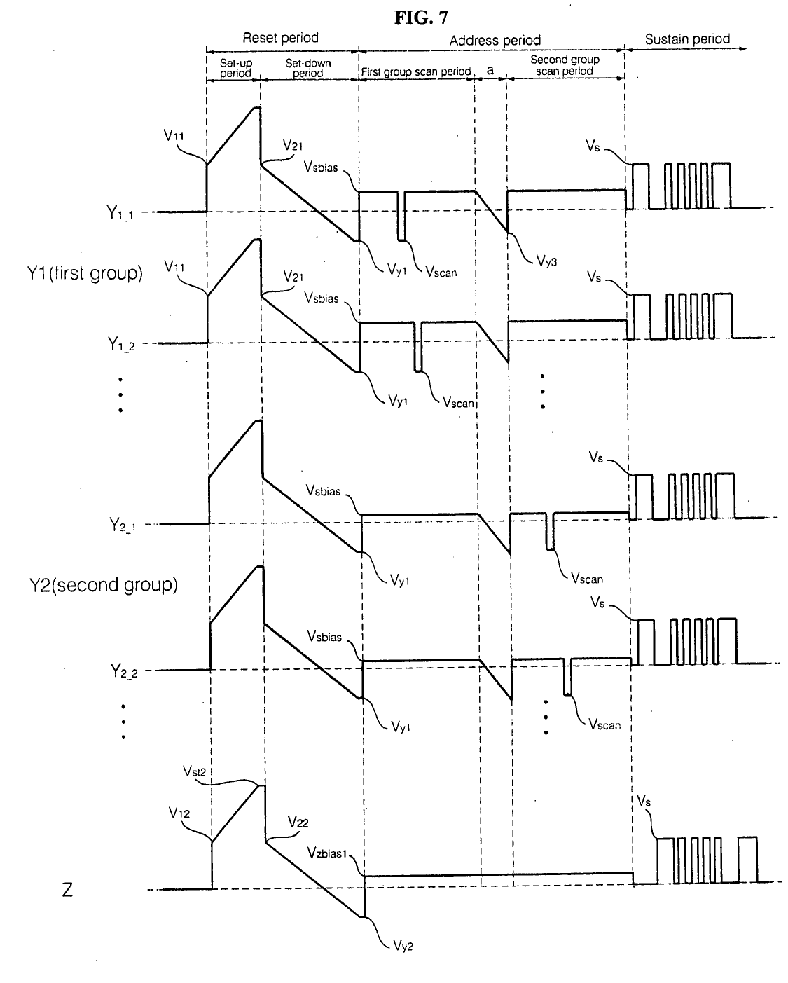

FIG. 7 is a timing diagram showing another embodiment with respect to driving signal waveforms, wherein the plurality of scan electrodes Y is divided into first and second groups and scan signals are sequentially supplied to the divided first and second groups. The same description as that given with reference to FIG. 5, of a description of the driving waveforms shown in FIG. 7, will not be given in order to avoid redundancy.

Referring to FIG. 7, an intermediate period “a” in which second set-down signals that gradually fall are supplied to the scan electrodes Y may exist between a first group scan period in which scan signals are sequentially supplied to the first group scan electrodes Y1 and a second group scan period in which scan signals are sequentially supplied to the second group scan electrodes Y2.

As described above, in a set-down period of a reset period, set-down signals that gradually fall are supplied to the scan electrodes Y, thereby erasing unnecessary charges of wall charges formed in a set-up period.

In the case in which the scan electrodes Y are divided into a plurality of groups and then sequentially supplied with scan signals, wall charges of negative (−) polarity, which have been formed in the scan electrodes Y2 belonging to the second group scan electrodes Y2 during the first group scan period, may be lost. Accordingly, in order to compensate for the loss of the wall charges, an amount of wall charges formed in the second group scan electrodes Y2 at a point of time at which the address period begins may be set greater than an amount of wall charges formed in the first group scan electrodes Y1.

For example, as shown in FIG. 7, the lowest voltages of the set-down signals, each supplied to the second group scan electrodes Y2 during the reset period, may rise (an absolute value decreases), so that an amount of wall charges formed in the second group scan electrodes Y2 may increase at a point of time at which the address period begins. Further, after the first group scan period is finished, signals that gradually fall may be supplied to the second group scan electrodes Y2 in order to erase unnecessary wall charges.

To this end, the lowest voltages of the first set-down signals, each supplied to the second group scan electrodes Y2 during the reset period, may differ from the lowest voltages of the second set-down signals, each supplied to the second group scan electrodes Y2 during the intermediate period “a”. More specifically, the lowest voltages of the first set-down signals may be higher than the lowest voltages of the second set-down signals.

Further, in order to compensate for the loss of wall charges formed in the second group scan electrodes Y2 more effectively, the lowest voltages of the first set-down signals, each supplied to the second group scan electrodes Y2 during the reset period, may have a value of 2 or more. In this case, the lowest voltages of set-down signals, each supplied to scan electrodes of the second group scan electrodes Y2 to which the scan signals are first supplied, may be lower than the lowest voltages of set-down signals, each supplied to scan electrodes of the second group scan electrodes Y2 to which the scan signals are later supplied.

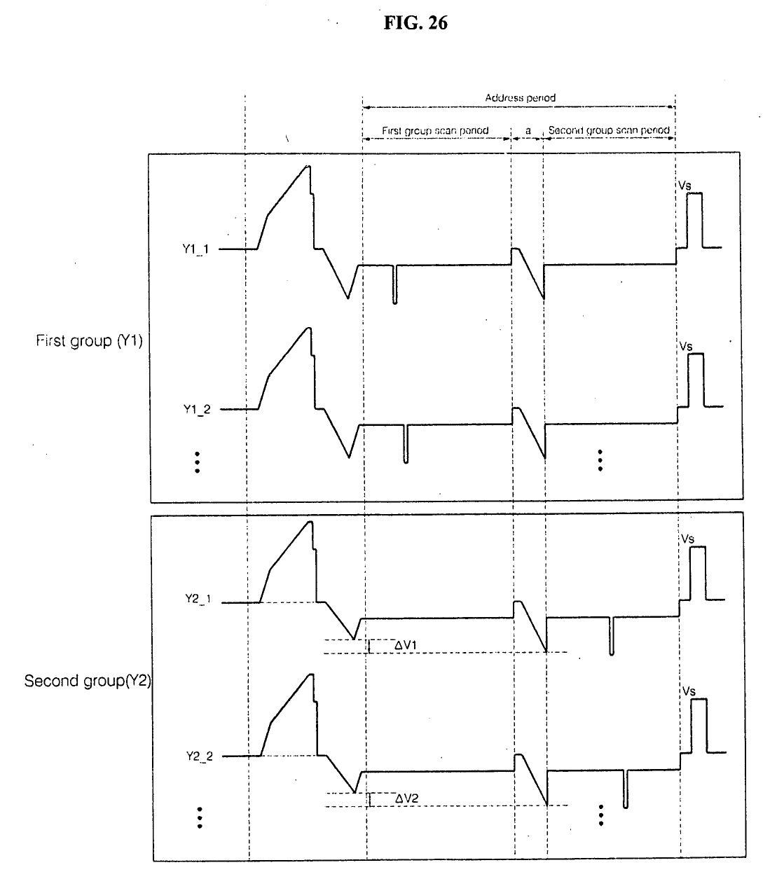

For example, a lowest voltage difference (ΔV2) between first and second set-down signals supplied to second scan electrodes Y2_2 of the second group Y2 may be greater than a lowest voltage difference (ΔV1) between first and second set-down signals supplied to a first scan electrode Y2_1 of the second group Y2. When considering easiness in terms of the configuration of a driving circuit that generates the driving signals of the above-described waveforms, second set-down signals that gradually fall may also be supplied to the first group scan electrodes Y1 during the intermediate period “a” between the first and second group scan periods, as shown in FIG. 26. In other words, in the case in which the second set-down signals are supplied to only the second group scan electrodes Y2 during the intermediate period “a”, circuit configurations for supplying the set-down signals must be different on a first- or second-group basis.

Referring to FIG. 7, a lowest voltage Vy1 of the set-down signal supplied to each of the first group scan electrodes Y1 during the reset period may be lower than a lowest voltage Vy2 of the set-down signal supplied to each of the second group scan electrodes Y2. Alternatively, when considering the easiness of a circuit configuration, the lowest voltage Vy1 may be identical to the lowest voltage Vy2.

For an easy configuration of a driving circuit, falling slopes of the first and second set-down signals may be identical. In this case, the lowest voltages of the first and second set-down signals may be changed as described above by controlling the widths of the set-down signals, i.e., falling times of the first and second set-down signals.

Further, an amount of the lowest voltage of the first set-down signal, which is supplied to each of the second group scan electrodes Y2 during the reset period, may be in inverse proportion to that of the lowest voltage of the second set-down signal, which is supplied to each of the second group scan electrodes Y2 during the intermediate period “a”. In other words, as the lowest voltage of the first set-down signal supplied to any one of the second group scan electrodes Y2 during the reset period becomes low, the lowest voltages of the second set-down signals, each supplied to the scan electrodes during the intermediate period “a”, may become high. As the lowest voltages of the first set-down signals, each supplied to the second group scan electrodes Y2 during the reset period, become low, an amount of wall charges, which have been formed in the scan electrodes at a point of time at which the address period begins, decreases. Accordingly, an amount where wall charges formed in the scan electrodes are erased may be reduced by raising the lowest voltage of the second set-down signal, each supplied to the scan electrodes during the intermediate period “a”. Accordingly, the second group scan electrodes Y2 may be sustained to a wall charge state suitable for an address discharge.

Unlike FIG. 7, the set-down signals may not be supplied to the second group scan electrodes Y2 during the reset period. Accordingly, the amount of negative (−) wall charges formed in the second group scan electrodes Y2 at the point of time at which the address period begins can be further increased.

Further, the scan bias voltages supplied to the second group scan electrodes Y2 may be variable.

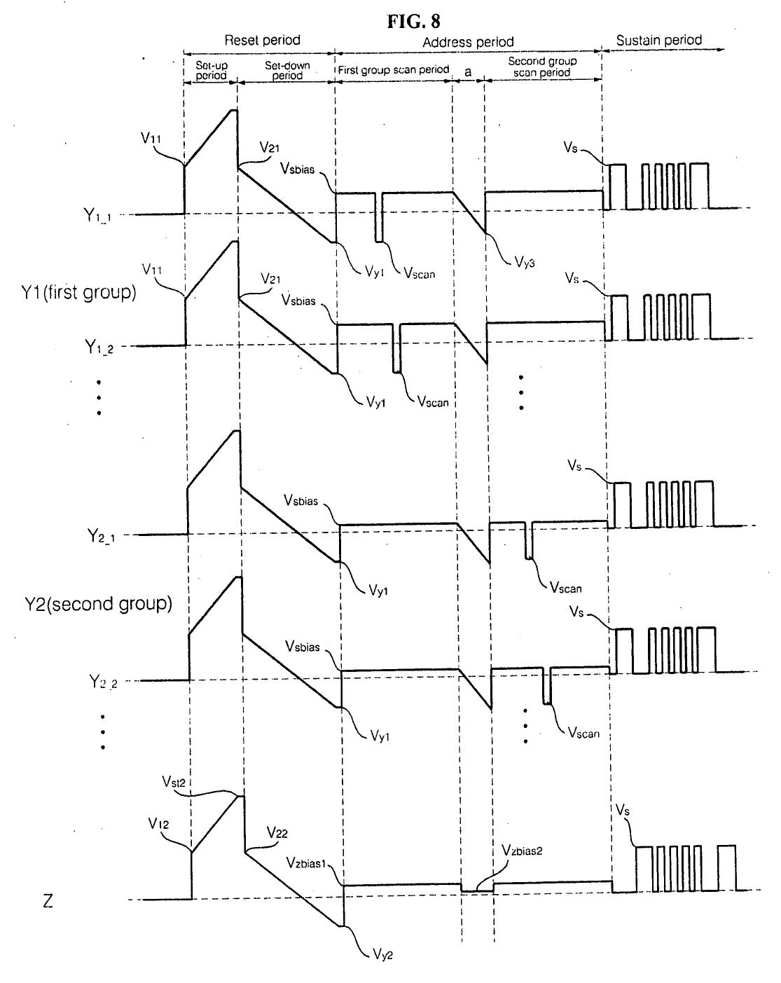

Further, as shown in FIG. 8, a sustain bias voltage (Vzbias2), which is supplied to the sustain electrode during the intermediate period “a” in which the second set-down signals are supplied, may be lower than a sustain bias voltage (Vzbias1), which is supplied to the sustain electrode during the first and second group scan periods. A potential between the sustain electrode and the scan electrodes having a gradually lowering voltage is reduced and, therefore, an erroneous discharge that may occur according to driving environment can be prevented.

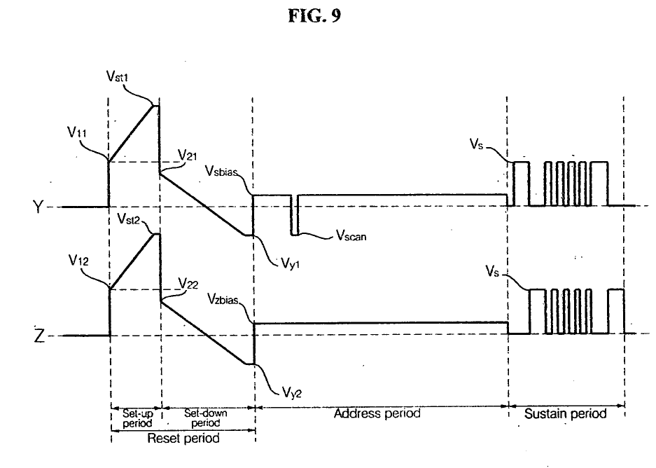

FIGS. 9 to 21 are timing diagrams showing embodiments with respect to driving signal waveforms of the panel according to the present invention. In FIGS. 9 to 21, the scan electrodes Y form at least one of the first and second groups. The embodiments of FIGS. 9 to 21 may be implemented in conjunction with the above-described embodiments of FIGS. 5 to 8.

Referring to FIG. 9, start voltages V21 and V22 of the first and second set-down signals may be lower than start voltages V11 and V12 of the first and second set-up signals. Accordingly, the amount of wall charges erased in the scan electrodes Y and the sustain electrodes Z during the set-down period may be decreased, thereby stabilizing an address discharge and a sustain discharge.

Further, the length of the set-down period can be shortened by lowering the start voltages V21 and V22 of the first and second set-down signals. Accordingly, in the state in which the length of the address period or the sustain period is relatively increased, a high-resolution panel in which 1080 or more scan lines are formed is driven. Accordingly, an address discharge and a sustain discharge can be stabilized, and sufficient panel driving margin can be secured.

However, in order to prevent a strong erroneous discharge from occurring in the set-down period, it may be preferred that the start voltages V21 and V22 of the first and second set-down signals be higher than the scan bias voltage (Vsbias) or the sustain bias voltage (Vzbias).

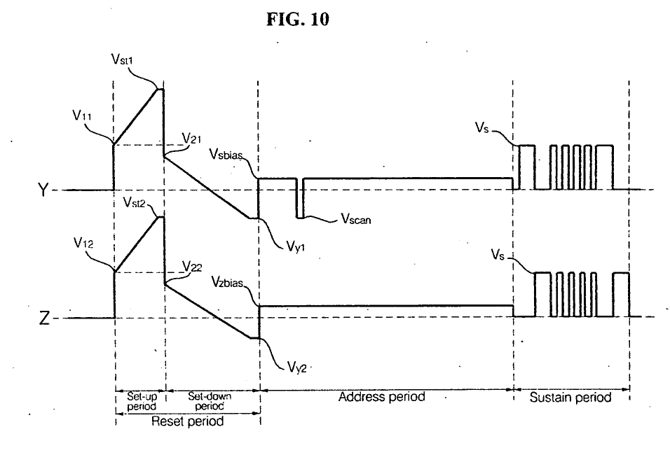

Referring to FIG. 10, the lowest voltage Vy2 of the second set-down signal may be higher than the lowest voltage Vy1 of the first set-down signal. Accordingly, the amount of wall charges erased in the sustain electrodes Z during the set-down period can be decreased, thereby stabilizing a sustain discharge.

In other words, the amount of wall charges formed in the sustain electrodes Z at a point of time at which the sustain period begins can be increased by raising the lowest voltage Vy2 of the second set-down signal. Accordingly, a potential between the scan electrodes Y and the sustain electrodes Z at a point of time at which the first sustain signals are supplied to the scan electrodes Y can be increased, thus stably generating a sustain discharge. Further, since the potential between the scan electrodes Y and the sustain electrodes Z at the point of time at which the sustain period begins increases, the sustain voltage (Vs) can be lowered and, therefore, consumption power necessary for panel driving can be saved.

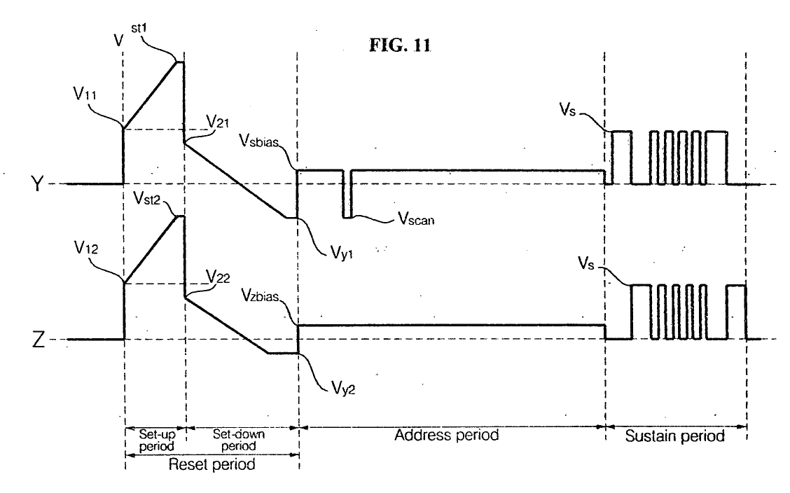

In the waveforms shown in FIG. 10, the lowest voltage Vy2 of the second set-down signal is higher than the lowest voltage Vy1 of the first set-down signal. Accordingly, a falling slope of the second set-down signal may be gentler than that of the first set-down signal, Referring to FIG. 11, the falling slopes of the first and second set-down signals may be identical, and the period in which the second set-down signal is supplied may be shorter than that in which the first set-down signal is supplied. Accordingly, the lowest voltage Vy2 of the second set-down signal may be higher than the lowest voltage Vy1 of the first set-down signal.

In the waveforms shown in FIG. 11, a sustain discharge can be stabilized by increasing the amount of wall charges formed in the sustain electrodes Z at a point of time at which the sustain period begins, and consumption power necessary for panel driving can be saved can be saved by lowering the sustain voltage (Vs).

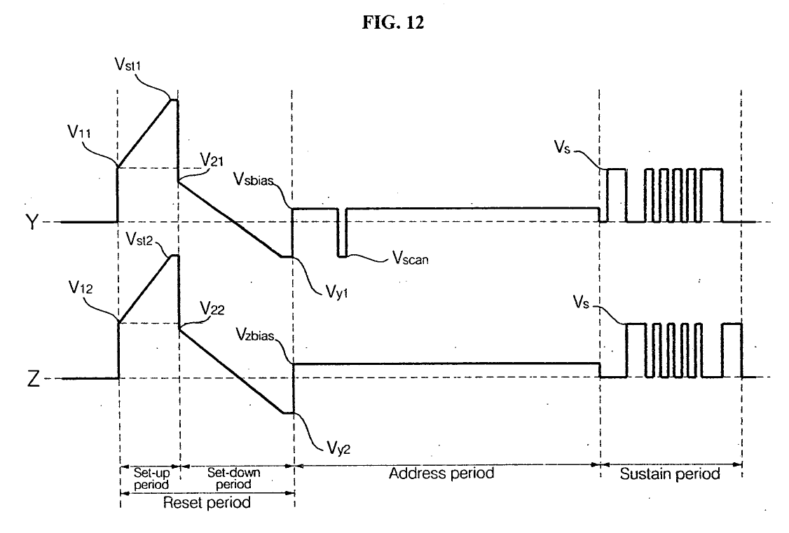

Referring to FIG. 12, the start voltage V22 of the second set-down signal may be higher than the start voltage V21 of the first set-down signal. Accordingly, the lowest voltage Vy2 of the second set-down signal may be higher than the lowest voltage Vy1 of the first set-down signal.

In the waveforms shown in FIG. 12, an amount where wall charges formed in the sustain electrodes Z during the set-down period is erased is decreased than an amount where wall charges formed in the scan electrodes Y during the set-down period. Thus, the amount of wall charges formed in the sustain electrodes Z at a point of time at which the sustain period begins can be increased. Accordingly, a sustain discharge can be stabilized, the sustain voltage (Vs) can be lowered, and consumption power necessary for panel driving can be saved.

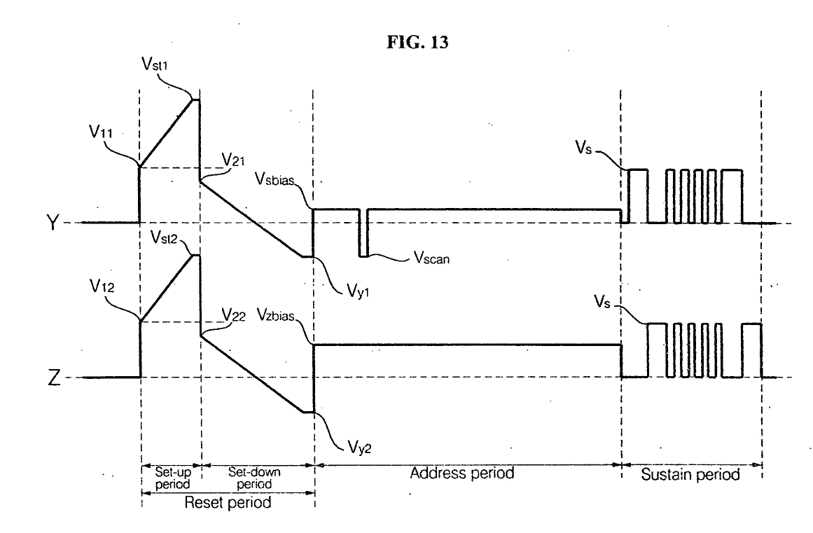

Referring to FIG. 13, the sustain bias voltage (Vzbias) supplied to the sustain electrodes Z during the address period may be higher than the scan bias voltage (Vsbias). As described above, the loss of negative wall charges of the sustain electrodes Z, which is generated during the address period, can be reduced by increasing the sustain bias voltage (Vzbias). Accordingly, the amount of wall charges formed in the sustain electrodes Z at a point of time at which the sustain period begins can be increased. Consequently, a sustain discharge can be stabilized, the sustain voltage (Vs) can be lowered, and consumption power necessary for panel driving can be saved.

However, in order to prevent an erroneous discharge from occurring between the scan electrodes Y and the sustain electrodes Z during the address period, the sustain bias voltage (Vzbias) supplied to the sustain electrodes Z during the address period may be preferably lower than the sustain voltage (Vs).

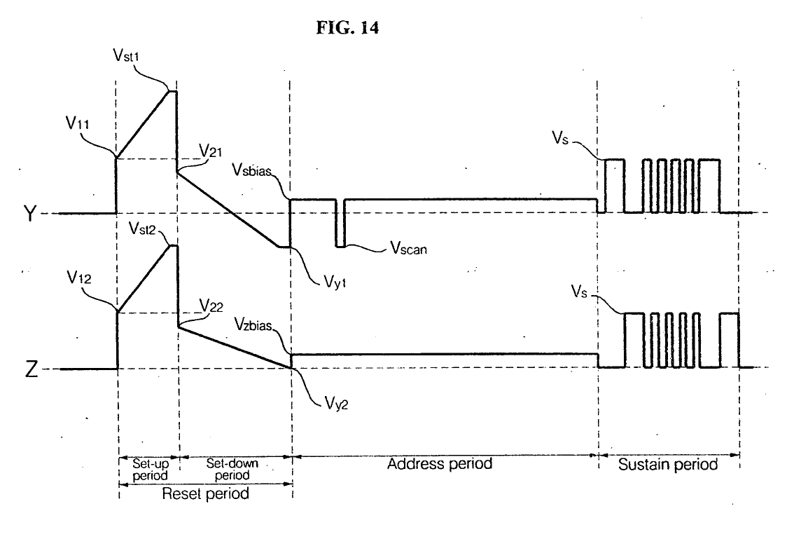

Referring to FIG. 14, in order to stabilize the above-described sustain discharge and easily configure a driving circuit, the first set-down signals supplied to the scan electrodes Y during the set-down period may fall from the voltage V21 to a negative voltage Vy1, and the second set-down signal supplied to the sustain electrodes Z may gradually fall from the voltage V22 to a ground voltage at a slope gentler than that of the first set-down signals.

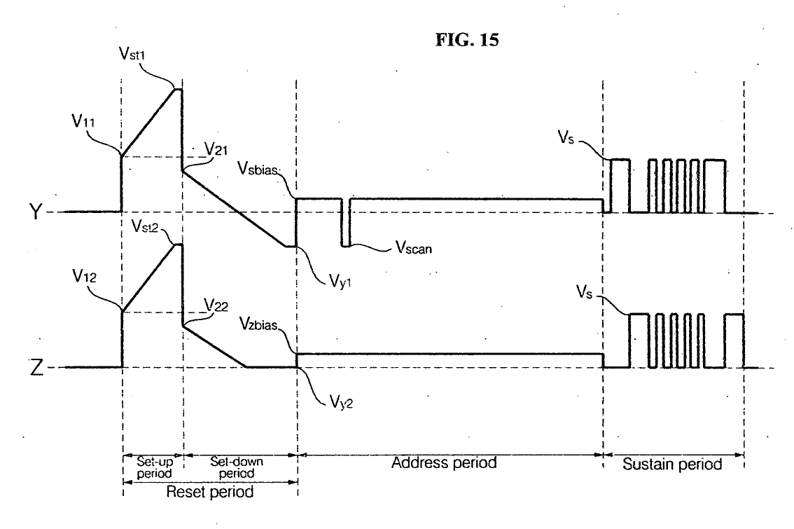

Referring to FIG. 15, in order to stabilize the above-described sustain discharge and easily configure a driving circuit, the first set-down signals supplied to the scan electrodes Y during the set-down period may fall from the voltage V21 to a negative voltage Vy1, and the second set-down signal supplied to the sustain electrodes Z may fall from the voltage V22 to a ground voltage during a period shorter than that of the first set-down signal. In this case, the falling slopes of the first and second set-down signals may be identical.

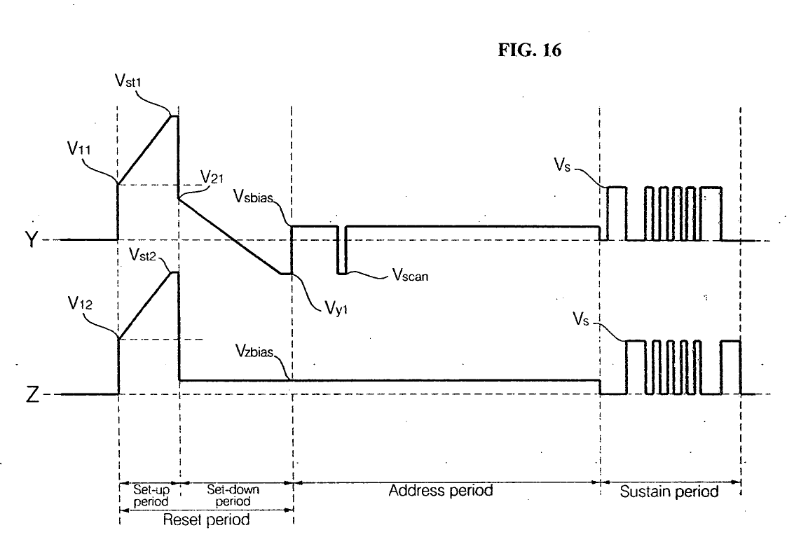

Referring to FIG. 16, voltage supplied to the sustain electrodes Z during the set-down period may have a constant value. Accordingly, a discharge between the sustain electrodes Z and the address electrodes X is not generated, so wall charges formed in the sustain electrodes Z may not be erased.

In this case, the amount of wall charges formed in the sustain electrodes Z at a point of time at which the sustain period begins can be increased. Accordingly, a potential between the scan electrodes Y and the sustain electrodes Z at a point of time at which the first sustain signals are supplied to the scan electrodes Y can be increased, thereby stably generating a sustain discharge. Further, since the potential between the scan electrodes Y and the sustain electrodes Z at the point of time at which the sustain period begins increases, the sustain voltage (Vs) can be lowered and, therefore, consumption power necessary for panel driving can be saved.

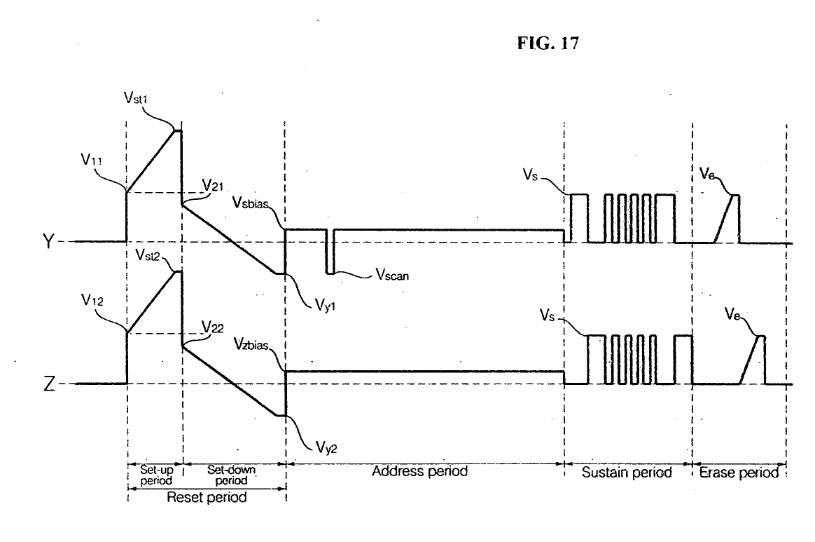

Referring to FIG. 17, after the sustain period, an erase signal may be supplied to the scan electrodes Y and the sustain electrodes Z.

As shown in FIG. 17, since a signal that gradually rises up to a specific voltage Ve is supplied to the scan electrodes Y and the sustain electrodes Z, wall charges formed in the scan electrodes Y and the sustain electrodes Z can be erased by a sustain discharge.

In the case of the plasma display apparatus according to the present invention, voltage of positive polarity may be supplied to the address electrodes X during the set-down period of the reset period. Accordingly, a discharge can be prevented from occurring between the sustain electrodes Z and the address electrodes X during the sustain period, so that panel driving margin can be secured.

Alternatively, a positive voltage may be supplied to the address electrodes X during the erase period shown in FIG. 17 in order to erase wall charges of positive polarity, formed in the address electrodes X. Accordingly, the reset efficiency of discharge cells can be improved.

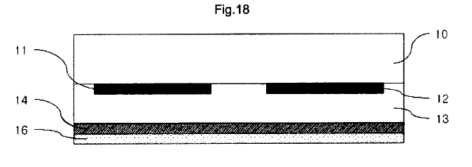

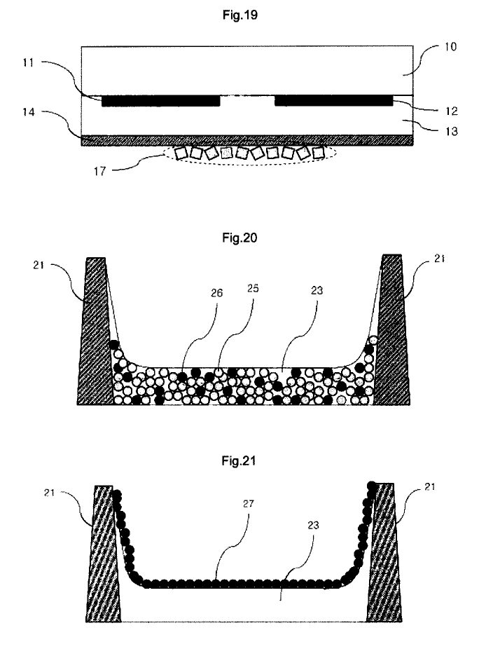

FIGS. 18 and 19 are sectional views showing embodiments with respect to the structure of the front substrate of the plasma display panel according to the present invention. The same description as that given with reference to FIG. 1, of the structure of the front substrate of the panel shown in FIGS. 18 and 19, will not be given in order to avoid redundancy.

Referring to FIG. 18, a scan electrode 11 and a sustain electrode 12 may be formed over a front substrate 10 of the panel, and a dielectric layer 13 may be stacked over the scan electrode 11 and the sustain electrode 12.

As described above, the scan electrode 11 and the sustain electrode 12 may have not only a stack structure of the transparent electrode and the bus electrode, but also only the bus electrodes without the transparent electrodes. The black matrices may be arranged on the scan electrode 11 and the sustain electrode 12. The black matrices may have a light-shielding function of reducing the reflection of external light by absorbing the light and a function of improving purity and contrast of the front substrate 10.

A protection layer 14 formed between the dielectric layer 13 and the discharge spaces may be formed from materials, which have many secondary electrons emitted when ions emitted from the discharge spaces collide against a surface and less surface damage due to the collision of ions, for example, magnesium oxide (MgO).

The discharge efficiency can be improved and firing voltage can be lowered by the secondary electrons emitted from the protection layer 14.

In the case of the plasma display panel according to the present invention, a crystal layer 16 may be formed on the protection layer 14. The crystal layer 16 may include materials, which have many secondary electrons emitted when ions emitted from the discharge spaces collide against a surface and less surface damage due to the collision of ions, for example, magnesium oxide (MgO) crystals.

When comparing peaks of light emitted when ions emitted from the discharge spaces collide against a surface, the crystal layer 16 may perform light emission having a peak at a wavelength region lower than that of the protection layer 14.

In other words, the crystal layer 16 may emit light, which has a peak at a wavelength region lower than that of the protection layer 14 when ions emitted from the discharge spaces collide against a surface. Accordingly, the discharge efficiency improved by the protection layer 14 may be further improved.

For example, the crystal layer 16 may include a plurality of magnesium oxide crystals having an average diameter of 500 Å or more, and the protection layer 14 may be comprised of magnesium oxide particles having a size much smaller than that of the magnesium oxide crystals.

A peak of light, which is emitted from the crystal layer 16 when ions emitted from the discharge spaces collide against a surface, may be located in a wavelength region lower than that of a peak of light, which is emitted from the protection layer 14, due to the size of the above-described magnesium oxide crystal.

The size of the magnesium oxide crystal included in the crystal layer 16 may be decided so that light, which has a wavelength region lower than that of a peak of light emitted from the protection layer 14 while not overlapping with the peak of light emitted from the protection layer 14, can be emitted from the crystal layer 16.

For example, a peak of light emitted from the crystal layer 16 when ions emitted from the discharge spaces collide against a surface may be located in a wavelength band of about 200 nm to 300 nm, and a peak of light emitted from the protection layer 14 may be located in a wavelength band of about 300 nm to 400 nm, which is slightly higher than the wavelength band of about 200 nm to 300 nm.

As described above, since the protection layer 14 and the crystal layer 16 having different emission peak regions are formed in the front substrate of the panel, the discharge efficiency can be further improved and a firing voltage can be lowered. Delay jitter of an address discharge can also be reduced by secondary electrons emitted from the two layers 14 and 16.

Accordingly, in a high-resolution panel in which 1080 or more scan electrode lines are formed such as Full HD panels, an erroneous address discharge that may occur due to a reduction in the distance between neighboring scan electrodes and the width of a scan signal can be reduced.

Referring to FIG. 19, a crystal layer 17, including a plurality of magnesium oxide crystals, may overlap with a scan electrode 11 and a sustain electrode 12, and may be formed on the basis of a gap between the scan electrode 11 and the sustain electrode 12.

A discharge is generated from the gap between the scan electrode 11 and the sustain electrode 12. Accordingly, the aperture ratio of the panel can be improved and the intensity of light emitted from the crystal layer 17 can be increased by forming the crystal layer 17 on the basis of the gap between the scan electrode 11 and the sustain electrode 12, as shown in FIG. 19.

FIGS. 20 and 21 are sectional views showing embodiments with respect to the structure of the rear substrate of the plasma display panel according to the present invention. The same description as that given with reference to FIG. 1, of the structure of the rear substrate of the panel shown in FIGS. 20 and 21, will not be given in order to avoid redundancy.

A phosphor layer 23 formed in a rear substrate of the plasma display panel according to the present invention may include a phosphor material, which generates a visible ray by exciting it with vacuum ultraviolet rays generated by a discharge, and a conductive material having conductivity higher than that of the phosphor material.

The conductive material included in the phosphor layer 23 may include several oxides such as magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), oxidized steel, euro-foam oxide (EuO), and cobalt oxide.

In the case in which the conductive material, such as magnesium oxide (MgO), is included in the phosphor layer 23 as described above, a discharge can become uniform and be stabilized. In other words, in the case in which a discharge is generated between the scan electrode and the address electrode, the conductive material functions as a catalyst of the discharge. Accordingly, a discharge can be stably generated between the scan electrode and the address electrode even with a low voltage.

The above-described reduction in the firing voltage may be possible because a discharge can be first generated at the portion where the oxide is disposed at a relatively low voltage before the discharge is generated due to the electrical characteristic of the oxide, such as magnesium oxide (MgO), and the generated discharge diffuses into the portion where the phosphor material is disposed.

Since the conductive material is included in the phosphor layer 23 as described above, the amount of electric charges of the phosphor layer 23 may be increased and, therefore, a firing voltage may be lowered. Furthermore, the delay of an address discharge may be reduced by secondary electrons emitted from the phosphor layer 23.

Further, if the amount of the conductive material included in the phosphor layer 23 increases, the discharge efficiency of the phosphor layer 23 may be further improved, but the luminance of a display image by a visible ray emitted from the phosphor layer 23 may be decreased.

Accordingly, in order to lower a firing voltage within an extent that does not significantly reduce the luminance of a display image, the conductive material may be used in an amount of 0.002 to 8 wt % based on the total amount of the phosphor layer 23 including the conductive material.

Through the above-described rear substrate structure of the panel, in a high-resolution panel in which 1080 or more scan electrode lines are formed such as Full HD panels, an erroneous address discharge that may occur due to a reduction in the distance between neighboring scan electrodes and the width of a scan signal may be reduced, and an increase of consumption power caused by an increase of electrode lines and a driving signal may be compensated for.

FIG. 20 is a sectional view showing a first embodiment with respect to the structure of the phosphor layer 23 including the conductive material.

Referring to FIG. 20, a phosphor material 25, which generates a visible ray by exciting it with vacuum ultraviolet rays, and a conductive material 26, such as MgO, may be included in the phosphor layer 23.

As described above, the conductive material 26 may be used in an amount of 0.002 to 8 wt % based on the total amount of the phosphor layer 23 including the conductive material. In order to easily add the conductive material 26 and prevent a reduction in the luminance of a display image, the particle size of the conductive material 26 may be smaller than that of the phosphor material 25.

FIG. 21 is a sectional view showing a second embodiment with respect to the structure of the phosphor layer 23 including the conductive material. As shown in FIG. 21, a conductive material 27, such as MgO, may be coated on a phosphor layer 23 formed from a phosphor material in order to reduce a firing voltage.

Each of a plurality of discharge cells included in the plasma display panel emits a visible ray corresponding to any one of a plurality of colors. For example, the plurality of discharge cells may be divided into an R discharge cell emitting a red visible ray, a G discharge cell emitting a green visible ray, and a B discharge cell emitting a blue visible ray. The R, G, and B discharge cells may include an R phosphor layer including a red phosphor material, a G phosphor layer including a green phosphor material, and a B phosphor layer including a blue phosphor material, respectively.

As described above, the discharge cells, each emitting a visible ray of a different color, include the phosphor layers formed from different phosphor materials, and may have different firing voltages according to the characteristics of the phosphor materials.

That is, the firing voltages of the discharge cells may differ according to the amount of electric charges, resistance, the content, etc. of the phosphor materials included in the phosphor layers. Accordingly, since driving signals have to be supplied in the state in which the voltage levels of the entire driving signals are set to the highest one of the firing voltages of the plurality of discharge cells, unnecessary power may be consumed.

Accordingly, in discharge cells having the highest firing voltage, of the discharge cells, each emitting a visible ray of a different color, a conductive material such as the above-described MgO may be included in the phosphor layer 23 in order to lower the firing voltage to a value similar to that of other discharge cells. Accordingly, the voltage levels of the entire driving signals can be lowered, and power consumed for panel driving can be saved.

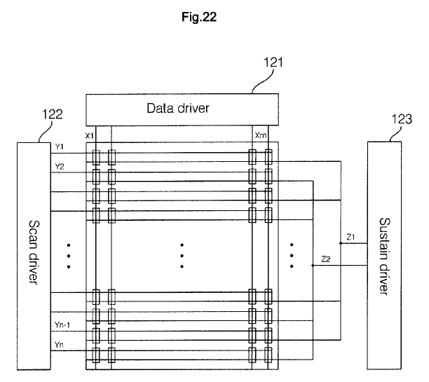

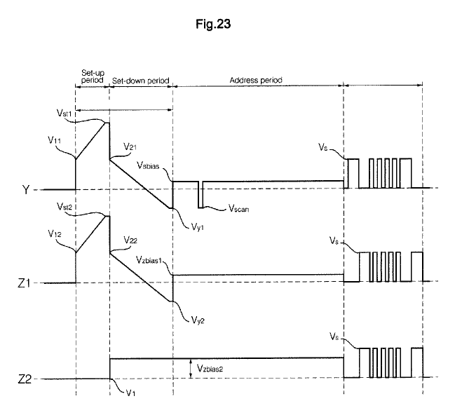

FIG. 22 is a diagram schematically showing the arrangement of electrode drivers of the plasma display panel according to an embodiment of the present invention. In FIG. 22, there are schematically shown the arrangement of the electrodes and the construction of the electrode drivers, which are included in the plasma display apparatus according to the present invention.

The plasma display apparatus includes a data driver 121 for supplying data to address electrodes X1 to Xm formed in a rear substrate (not shown), a scan driver 122 for driving scan electrodes Y1 to Yn, and a sustain driver 123 for driving sustain electrodes Z.

The plasma display apparatus further includes a timing controller (not shown) for controlling the data driver 121, the scan driver 122, and the sustain driver 123 when a panel is driven, and a driving voltage generator (not shown) for supplying driving voltages necessary for the respective drivers 121, 122, and 123.

A number of electrodes, for example, the scan electrodes Y1 to Yn and the sustain electrodes Z are formed in pairs in a front substrate. The address electrodes X1 to Xm are formed in the rear substrate in a direction crossing the scan electrodes Y1 to Yn and the sustain electrodes Z.

In the sequence of electrode arrangements, the sustain electrodes formed in the front substrate may be divided into an odd-numbered electrodes Z1 and an even-numbered electrodes Z2 as shown in FIG. 22, thereby forming a sustain electrode group. Although the sustain electrode groups are divided into the odd- and even-numbered electrodes and thus two, i.e., first and second groups in FIG. 22, the number of the sustain electrode groups may be two or more.

Further, the sustain electrodes may not be divided on a group basis, such as the odd and even numbers, but may be divided in the sequence of the sustain electrodes being disposed on an upper side and a lower side.

Alternatively, the number of the sustain electrodes belonging to each of a plurality of sustain electrode groups may be identical, and the number of the sustain electrodes belonging to at least one of a plurality of sustain electrode groups may differ.

The sustain driver 123 may supply a bias voltage of positive polarity to the sustain electrodes Z1 and Z2 during a set-down period and an address period. The sustain driver 123 may also supply a signal, which is similar to a reset signal supplied to the scan electrodes during a reset period, to the sustain electrodes.

Referring to FIG. 23, during a set-up period of a reset period, a first set-up signal gradually rising from a V11 voltage to a Vst1 voltage may be supplied to the scan electrodes Y, and a second set-up signal gradually rising from a V12 voltage to a Vst2 voltage may be supplied to the sustain electrodes Z1 of the first group.

Although an embodiment in which a signal similar to the reset signal is supplied to the sustain electrode of the first group and a bias voltage is supplied to the sustain electrode of the second group has been described with reference to FIG. 23, a signal similar to the reset signal may also be supplied to the sustain electrode of the second group.

As described above, in the case of a high-resolution panel in which 1080 or more scan electrode lines are formed such as a Full HD panel, there may be a high possibility that an erroneous discharge, etc. may occur due to mutual influence between electrodes because a gap between the electrodes is narrowed, for example, cross talk.

Accordingly, in the case of the plasma display panel according to the present invention, a plurality of electrodes formed in the panel is divided into 2 or more groups and then driven. Accordingly, mutual influence, such as cross talk between the electrodes of the panel, can be reduced and an erroneous address discharge can also be improved.

As described above, since the first and second set-up signals that gradually rise are supplied to the scan electrodes Y and the first group Z1 during the set-up period, a difference in the amount of wall charges formed in the scan electrodes Y and the sustain electrodes Z of the first group during the set-up period may be decreased. Accordingly, an erroneous discharge that may occur between the scan electrodes Y and the sustain electrodes Z1 of the first group during an address period may be reduced, and the discharge efficiency between the scan electrodes Y and the address electrodes X may be improved.

For example, the V11 voltage may be identical to the V12 voltage, and the Vst1 voltage may be identical to the voltage Vst2. Accordingly, the rising slopes of the first and second set-up signals may be identical. In this case, a potential between the scan electrodes Y and the address electrodes X becomes identical to that between the sustain electrodes Z1 of the first group and the address electrodes X, so the amount of wall charges formed in the scan electrodes Y during the set-up period may almost become identical to that formed in the sustain electrodes Z1 of the first group during the set-up period. Accordingly, even if a panel is driven under high temperature environment of 50 degrees Celsius or more, an erroneous address discharge depending on a shift in wall charges can be prevented.

Unlike FIG. 23, a period in which the first set-up signal is supplied to the scan electrodes Y may not be exactly identical to a period in which the second set-up signal is supplied to the sustain electrodes Z1 of the first group.

Further, a first set-down signal gradually falling from a voltage V21 to a Vy1 voltage may be supplied to the scan electrodes Y during a set-down period of the reset period, and a second set-down signal gradually falling from a V22 voltage to a Vy2 voltage may be supplied to the sustain electrodes Z1 of the first group.

As described above, since the first and second set-down signals that gradually fall are respectively supplied to the scan electrodes Y and the sustain electrodes Z1 of the first group during the set-down period, charges unnecessary for an address discharge, of wall charges formed in the scan electrodes Y and the sustain electrodes Z1 of the first group, can be erased. Accordingly, an erroneous discharge between the scan electrodes Y and the address electrodes X or between the sustain electrodes Z1 of the first group and the address electrodes X during the address period can be reduced, and a discharge can also be prevented from occurring in off cells during a sustain period.

For example, the V21 voltage may be identical to the V22 voltage, and the Vy1 voltage may be identical to the voltage Vy2. Accordingly, the falling slopes of the first and second set-down signals may be identical. In this case, a potential between the scan electrodes Y and the address electrodes X becomes identical to that between the sustain electrodes Z1 of the first group and the address electrodes X, so the amount of wall charges formed in the scan electrodes Y during the set-down period may almost become identical to that formed in the sustain electrodes Z1 of the first group during the set-down period. Accordingly, an erroneous discharge that may occur between the scan electrodes Y and the sustain electrodes Z1 of the first group during the address period can be reduced.

Unlike FIG. 23, a period in which the first set-down signal is supplied to the scan electrodes Y may not be exactly identical to a period in which the second set-down signal is supplied to the sustain electrodes Z1 of the first group.

Further, a scan bias voltage (Vsbias) supplied to the scan electrodes Y during the address period may be identical to sustain bias voltages (Vzbias1, Vzbias2) supplied to the sustain electrodes Z1 and Z2 of the first and second groups. As described above, since a potential between the scan electrodes Y and the sustain electrodes Z is reduced during the address period, an erroneous discharge between the scan electrodes Y and the sustain electrodes Z during the address period can be reduced.

As an amount where wall charges formed in the scan electrodes Y are erased during the set-down period increases, an address discharge between the scan electrodes Y and the address electrodes X may become unstable. As an amount where wall charges formed in the sustain electrodes Z are erased during the set-down period increases, a first sustain discharge may become unstable.

Accordingly, the lowest voltages Vy1 and Vy2 of the first and second set-down signals may be set higher than a voltage (Vscan) in order to reduce the amount of wall charges erased in the scan electrodes Y and the sustain electrodes Z1 of the first group during the set-down period.

As described above, in the case of a high-resolution panel in which 1080 or more scan electrode lines are formed such as a Full HD panel, there may be a high possibility that an erroneous discharge, etc. may be generated due to mutual influence between electrodes because a gap between the electrodes is narrowed, for example, cross talk.

Accordingly, in the case of the plasma display panel according to the present invention, a plurality of electrodes formed in the panel is divided into 2 or more groups and then driven. Accordingly, mutual influence, such as cross talk between the electrodes of the panel, can be reduced, and an erroneous address discharge can also be improved. In other words, the plurality of scan electrodes is divided into 2 or more groups and scan signals are supplied on a divided-group basis. Accordingly, 1080 or more scan electrodes formed in a panel can be driven effectively while minimizing mutual influence between lines.

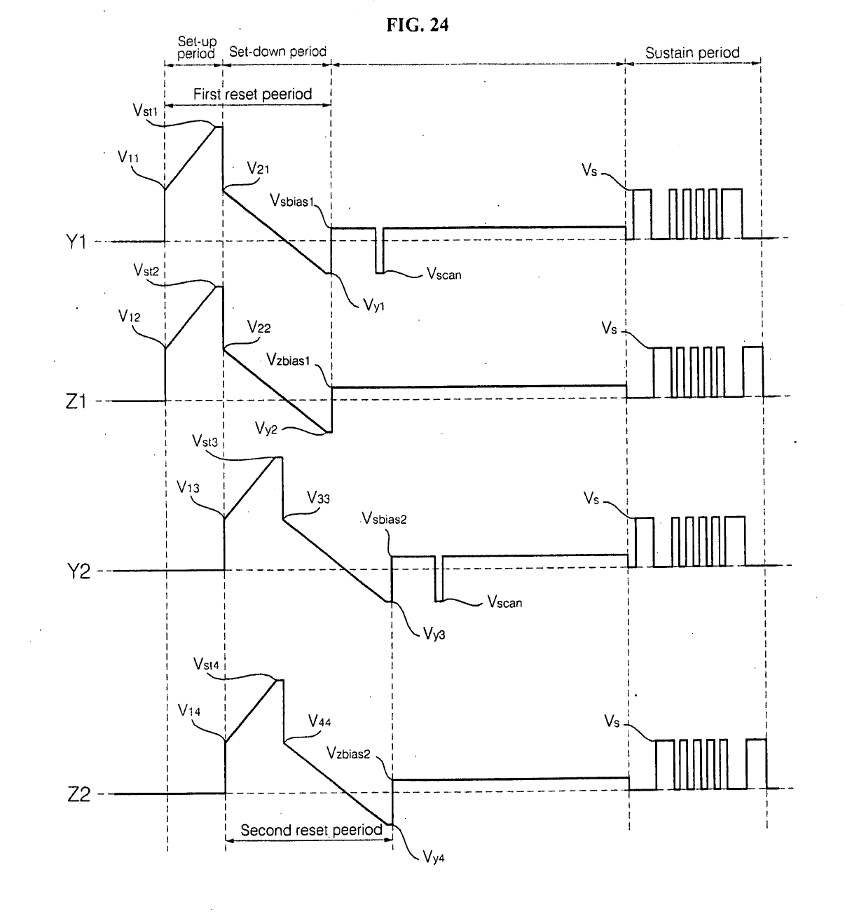

FIGS. 24 to 26 are timing diagrams showing embodiments with respect to driving signal waveforms of a plasma display panel.

FIG. 24 shows an embodiment in which sustain electrodes and scan electrodes are divided into a plurality of groups so that corresponding sustain electrodes and scan electrodes are included in one discharge cell and then separately driven.

A plurality of sustain electrodes is divided into two or more groups including a first sustain group and a second sustain group, a plurality of scan electrodes is divided into two or more groups including a first scan group and a second scan group, and, while voltage supplied to the first scan group gradually rises from a first voltage to a second voltage in a reset period of at least one of a plurality of subfields constituting one frame, voltage supplied to the first sustain group may be configured to gradually rise from a third voltage to a fourth voltage.

Although FIG. 24 shows an embodiment in which points of time at which reset signals are supplied to the first and second scan groups, which are divided and driven, differ, the points of time at which the reset signals are supplied may be identical.

Referring to FIG. 24, during a set-up period of a reset period, a first set-up signal gradually rising from a V11 voltage to a Vst1 voltage may be supplied to a first scan group Y1, and a second set-up signal gradually rising from a V12 voltage to a Vst2 voltage may be supplied to the first sustain group Z1.

As described above, since the first and second set-up signals that gradually rise are supplied to the scan electrodes Y and the sustain electrodes Z during the set-up period, a difference between the amount of wall charges formed in the scan electrodes Y and the amount of wall charges formed in the sustain electrodes Z, during the set-up period, can be reduced. Accordingly, an erroneous discharge that may be generated between the scan electrodes Y and the sustain electrodes Z during an address period can be reduced, and the discharge efficiency between the scan electrodes Y and the address electrodes X can also be reduced.

The embodiment of FIG. 24 differs from the embodiment of FIG. 23 in that the plurality of scan electrodes is divided and driven. The signals supplied to the first scan group and the first sustain group are similar to that of FIG. 23 and, therefore, similar portions to those of FIG. 23 will not be described.

The reset signal supplied to the second scan group may be posterior to the reset signal supplied to the first scan group. In scan electrodes having a late scan sequence, a period until a point of time at which the scan signals are supplied to the scan electrodes since the reset period is finished is later than that of the first scan group. Accordingly, the scan electrodes having a late scan sequence may have a greater amount of wall charges lost during that period and may have an erroneous address discharge according to driving environment. Accordingly, the amount of wall charges, which are lost in the second scan group until an address discharge is generated, can be decreased by reducing a period between a point of time at which the second scan group to which the reset signal is supplied late is scanned and a point of time at which the supply of the reset signal is finished. As in FIG. 24, a fourth set-up signal may be supplied to the second sustain group so that the fourth set-up signal corresponds to a point of time at which a third set-up signal is supplied to the second scan group.

Further, in the case in which the points of time at which the reset signals are supplied to the first and second scan groups are the same, maximum values of the voltages Vst1 and Vst3 of the reset signals may be configured to differ in the first and second scan groups. For example, if a maximum value of the reset signal supplied to the second scan group, having a late scan sequence, increases, the amount of wall charges generated by a set-up discharge can increase, and the amount of wall charges accumulated at the time of an address discharge can be increased. Accordingly, an erroneous address discharge can be prevented.

Since the third and fourth set-up signals that gradually rise are respectively supplied to the scan electrodes Y and the sustain electrodes Z during a set-up period, a difference between the amount of wall charges formed in the scan electrodes Y and the amount of wall charges formed in the sustain electrodes Z during the set-up period can be reduced. Accordingly, an erroneous discharge that may occur between the scan electrodes Y and the sustain electrodes Z during the address period can be reduced, and the discharge efficiency between the scan electrodes Y and the address electrodes X can also be improved.

Meanwhile, the driving waveforms of FIGS. 9 to 17, showing various embodiments with respect to the waveforms supplied to the scan electrodes and the sustain electrodes during the reset period, may be implemented in combination with not only the embodiment of FIG. 23, but the embodiment of FIG. 24. Accordingly, a change in the voltage values, a difference in the slopes, and so on in FIGS. 9 to 17 may also be similarly applied to a pair of sustain electrode groups to which waveforms, corresponding to that of scan electrodes groups, are supplied even in the case in which the plurality of scan electrodes and sustain electrodes shown in FIG. 24 are divided into respective groups and then driven.

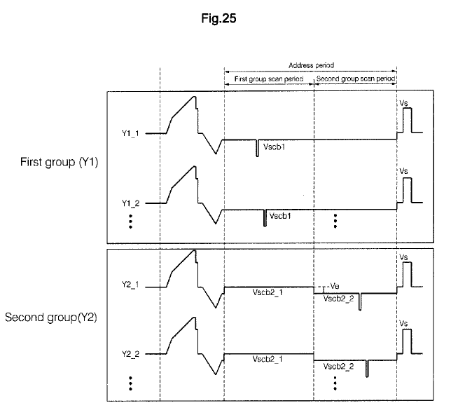

FIGS. 25 and 26 show another embodiments of the present invention on the basis in which a plurality of scan electrodes is divided and driven.

Referring to FIG. 25, a plurality of scan electrodes Y formed in a panel may be divided into at least two groups Y1 and Y2. An address period may be divided into first and second group scan periods in which scan signals are respectively supplied to the divided first and second groups. After scan signals are sequentially supplied to the scan electrodes Y1 belonging to the first group during the first group scan period, scan signals may be sequentially supplied to the scan electrodes Y2 belonging to the second group during the second group scan period.

For example, the plurality of scan electrodes Y may be divided into the first group Y1, which is located at an even-numbered position, and the second group Y2, which is located at an odd-numbered position, from a top end of the panel depending on positions where the groups are formed on the panel. In another embodiment, the plurality of scan electrodes Y may be divided into the first group Y1 located on an upper side and the second group Y1 located on a lower side on the basis of the center of the panel. The plurality of scan electrodes Y may be divided according to several methods other than the above method, and the number of the scan electrodes respectively belonging to the first and second groups Y1 and Y2 may differ.

During a reset period, charges of negative (−) polarity are formed in the scan electrodes Y for an address discharge and, during an address period, driving signals supplied to the scan electrodes Y are sustained to a scan bias voltage and scan signals of negative polarity are then sequentially to the scan electrodes Y, so that an address discharge is generated.

In the case in which the plurality of scan electrodes Y is divided into the first and second groups and then sequentially supplied with the scan signals, the first group scan period in which the scan signals are supplied to the first group Y1, wall charges of negative (−) polarity, which have been formed in the scan electrodes Y2 belonging to the second group Y2, may be lost. Accordingly, an erroneous address discharge in which an address discharge is not generated although the scan signals are supplied to the scan electrodes Y2 belonging to the second group Y2 during the second group scan period may be generated.

Accordingly, as shown in FIG. 25, a scan bias voltage (Vscb2_1) supplied to the second group Y2 is increased until the second group scan period in which the scan signals are supplied to the second group Y2 after the reset period, for example, during the first group scan period, so that the loss of negative (−) wall charges formed in the scan electrodes belonging to the second group Y2 can be decreased.

That is, the scan bias voltages (Vscb2_1), which are greater than scan bias voltages (Vscb1) supplied to the first group scan electrodes Y1 in the first group scan period, may be supplied to the second group scan electrodes Y2 in order to reduce an erroneous address discharge.

The scan bias voltages (Vscb2_1) supplied to the second group scan electrodes Y2 during the first group scan period may be preferably smaller than sustain voltages (Vs). If the scan bias voltages (Vscb2_1) are smaller than the sustain voltages (Vs), an increase of unnecessary power consumption can be prevented, and the occurrence of a spot erroneous discharge depending on an increased amount of wall charges in the scan electrodes can be reduced.

During the first group scan period, scan bias voltages of negative polarity are supplied to the first group scan electrodes Y1. When the scan signals are supplied to the scan electrodes, a potential between the scan signals supplied to the scan electrodes and data signals supplied to the address electrodes as a bias voltage of negative polarity is increased, so a discharge is generated easily.

In order to easily generate an address discharge by increasing the potential between the scan signal supplied to the scan electrodes and the data signal of positive polarity, which is supplied to the address electrodes X during the address period, the scan bias voltages (Vscb1) supplied to the first group scan electrodes Y1 during the first group scan period and scan bias voltages (Vscb2_2) supplied to the second group scan electrodes Y2 during the second group scan period may have negative polarity. Accordingly, when considering an easy configuration of a driving circuit, the scan bias voltages (Vscb2_1) supplied to the second group scan electrodes Y2 during the first group scan period may be ground voltage, and the scan bias voltages Vcb1 supplied to the first group scan electrodes Y1 during the address period may be constant.

Referring to FIG. 25, the scan bias voltages supplied to the second group scan electrodes Y2 during the address period may change. More specifically, the scan bias voltages (Vscb2_1) supplied to the second group scan electrodes Y2 during the first group scan period of the address period may be greater than the scan bias voltages (Vscb2_2) supplied to the second group scan electrodes Y2 during the second group scan period of the address period.

In the case in which a plurality of scan electrodes is divided into the first group Y1 located at an even-numbered position and the second group Y2 located at an odd-numbered position, different scan bias voltages (Vscb1 and Vscb2_1) are supplied to the first and second group scan electrodes Y1 and Y2 during the first group scan period as described above, so that influence depending on interference between neighboring discharge cells can be reduced.

Further, the scan bias voltages (Vsc2_1) supplied to the scan electrodes Y2 belonging to the second group during the first group scan period may have a value of 2 or more. In this case, during the first group scan period, higher scan bias voltages (Vscb2_1) may be supplied to scan electrodes of the second group scan electrodes Y2 to which the scan signals are first supplied than scan electrodes of the second group scan electrodes Y2 to which the scan signals are next supplied. Accordingly, the loss of wall charges formed in the scan electrodes during the reset period can be reduced more effectively.

The driving waveforms as described with reference to FIG. 25 may be applied to some of a plurality of subfields constituting one frame and, for example, may be applied to at least one of subfields subsequent to the second subfield.

FIG. 26 is a timing diagram showing another embodiment with respect to driving signal waveforms, in which a plurality of scan electrodes Y is divided into first and second groups and then sequentially supplied with scan signals. The same description as that given with reference to FIG. 25, of a description of driving waveforms shown in FIG. 26, will not be given for simplicity.

Referring to FIG. 26, an intermediate period “a” in which signals that gradually fall are supplied to the scan electrodes Y may exist between a first group scan period in which scan signals are sequentially supplied to the first group scan electrodes Y1 and a second group scan period in which scan signals are sequentially supplied to the second group scan electrodes Y1.

As described above, during a set-down period of a reset period, set-down signals that gradually fall are supplied to the scan electrodes Y, thereby erasing unnecessary ones of wall charges formed during a set-up period.

In the case in which the scan electrodes Y are divided into a plurality of groups and then sequentially supplied with the scan signals, wall charges of negative (−) polarity, which have been formed in the scan electrodes Y2 belonging to the second group scan electrodes Y2, may be lost during the first group scan period. Accordingly, the amount of wall charges formed in the second group scan electrodes Y2 at a point of time at which an address period begins may become greater than the amount of wall charges formed in the first group scan electrodes Y1 in order to compensate for the loss of wall charges.

For example, an amount of wall charges formed in the second group scan electrodes Y2 at a point of time at which the address period begins may increase by raising the lowest voltages (an absolute value decreases) of the set-down signals, each supplied to the second group scan electrodes Y2 during the reset period, as shown in FIG. 26. Further, after the first group scan period is finished, signals that gradually fall may be supplied to the second group scan electrodes Y2 in order to erase unnecessary wall charges.

To this end, the lowest voltages of the first set-down signals, each supplied to the second group scan electrodes Y2 during the reset period, may differ from the lowest voltages of the second set-down signals, each supplied to the second group scan electrodes Y2 during the intermediate period “a”. More specifically, the lowest voltages of the first set-down signals may be higher than the lowest voltages of the second set-down signal.

Further, in order to compensate for the loss of wall charges formed in the second group scan electrodes Y2 more effectively, the lowest voltages of the first set-down signals, each supplied to the second group scan electrodes Y2 during the reset period, may have a value of 2 or more. In this case, the set-down signals, having a higher lowest voltage, may be supplied to scan electrodes to which the scan signals are later supplied, of the second group scan electrodes Y2, than scan electrodes to which the scan signals are first supplied, of the second group scan electrodes Y2.

For example, a difference (ΔV2) between the lowest voltages of the first and second set-down signals supplied to a second scan electrode Y2_2 of the second group Y2 may be greater than a difference (ΔV1) between the lowest voltages of the first and second set-down signals supplied to a first scan electrode Y2_1.

When considering an easy configuration of a driving circuit that generates driving signals of the above-described waveforms, second set-down signals that gradually fall may also be supplied to the first group scan electrodes Y1 during the intermediate period “a” between the first and second group scan periods, as shown in FIG. 26. In other words, in the case in which the second set-down signals are supplied to only the second group scan electrodes Y2 during the intermediate period “a”, circuit configurations for supplying the set-down signals must be different on a first- or second-group basis.

Referring to FIG. 26, the lowest voltages of the set-down signals supplied to the first group scan electrodes Y1 during the reset period may be lower than the lowest voltages of the set-down signals supplied to the second group scan electrodes Y2. Further, when considering the easiness of a circuit configuration, the lowest voltages of the first set-down signals supplied to the first group scan electrodes Y1 during the reset period may be identical to the lowest voltages of the second set-down signals supplied to the first and second group scan electrodes Y1 and Y2 during the intermediate period “a”.

In order to facilitate the configuration of a driving circuit, the falling slopes of the first and second set-down signals may be identical. In this case, the lowest voltages of the first and second set-down signals may be changed, as described above, by controlling the widths of the set-down signals, i.e., the falling times of the first and second set-down signals.

Further, an amount of the lowest voltage of the first set-down signal, which is supplied to each of the second group scan electrodes Y2 during the reset period, may be in inverse proportion to an amount of the lowest voltage of the second set-down signal, which is supplied to each of the second group scan electrodes Y2 during the intermediate period “a”. That is, as the lowest voltage of the first set-down signal supplied to any one of the second group scan electrodes Y2 during the reset period becomes low, the lowest voltages of the second set-down signals, each supplied to the scan electrodes during the intermediate period “a”, may become high. As the lowest voltages of the first set-down signals, each supplied to the second group scan electrodes Y2 during the reset period, become low, an amount of wall charges, which have been formed in the scan electrodes at a point of time at which the address period begins, decreases. Accordingly, an amount where wall charges formed in the scan electrodes are erased may be reduced by raising the lowest voltages of the second set-down signals, each supplied to the scan electrodes during the intermediate period “a”. Accordingly, the second group scan electrodes Y2 may be sustained to a wall charge state suitable for an address discharge.

Unlike FIG. 26, the set-down signals may not be supplied to the second group scan electrodes Y2 during the reset period. Accordingly, the amount of negative (−) wall charges formed in the second group scan electrodes Y2 at the point of time at which the address period begins can be further increased.

The driving waveforms as described above with reference to FIG. 26 may be applied to some of a plurality of subfields constituting one frame and, for example, may be applied to at least one of subfields subsequent to the second subfield. Further, as shown in FIG. 25, scan bias voltages supplied to the second group scan electrodes Y2 may be variable.

An example in which the plurality of scan electrodes formed in the panel is divided into two groups and then driven has been described with reference to FIGS. 25 and 26. However, in the case of the plasma display apparatus according to the present invention, the plurality of scan electrodes may be divided into 3 or more groups and then driven by the driving waveforms as shown in FIGS. 25 and 26.

For example, the first and second group scan electrodes Y1 and Y2 shown in FIGS. 25 and 26 may be divided into a plurality of subgroups. In this case, the plurality of scan electrodes may be sequentially supplied with scan signals in the sequence of the first and second groups, and scan signals may be sequentially supplied on a subgroup basis within the first and second groups.

Further, falling periods of the set-down signals, each supplied to the scan electrodes Y and the sustain electrodes Z during the reset period, may have a discontinuous waveform. That is, the falling periods of the set-down signals may include a first falling period that gradually falls up to a first voltage, a sustain period that is sustained to the first voltage, and a second falling period that gradually falls from the first voltage. Further, the set-down signal may include 2 or more of the above-described sustain periods. Since the set-down signals respectively having discontinuous falling periods to the scan electrodes during the reset period as described above, an amount of wall charges formed in the scan electrodes Y and the sustain electrodes Z at a point of time at which the address period begins can be increased and, therefore, an address discharge and a sustain discharge can be stabilized.

The above-described driving waveforms may be applied to some of a plurality of subfields constituting one frame and, for example, may be applied to at least one of subfields subsequent to the second subfield.

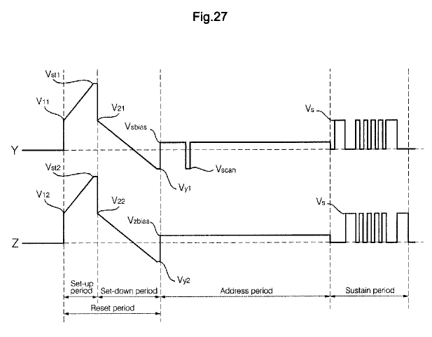

FIG. 27 is a timing diagram showing an embodiment with respect to driving signal waveforms of a panel according to the present invention.

In the plasma display apparatus according to an embodiment of the present invention, the number of scan electrode lines formed in the panel may be 1080 or more, and the width of a scan signal supplied to each of the scan electrodes may be 0.7 μs to 1.1 μs. In a reset period of at least one of a plurality of subfields constituting one frame, during a set-up period, voltages supplied to scan electrodes may gradually rise from a first voltage to a second voltage, and voltages supplied to sustain electrodes may gradually rise from a third voltage to a fourth voltage.

Referring to FIG. 27, during a set-up period of a reset period, a first set-up signal, gradually rising from a V11 voltage to a Vst1 voltage, may be supplied to the entire scan electrodes Y, and a second set-up signal, gradually rising from a V12 voltage to a Vst2 voltage, may be supplied to the entire sustain electrodes Z.

In the case in which the width of a scan signal is set to 1.5 μs or less in order to drive a panel in which the number of scan electrode lines is 1080 or more such as a Full HD panel, a possibility that an erroneous address discharge may be generated may rise depending on a reduction in the address discharge efficiency.

As described above, since the first and second set-up signals the gradually rise are supplied to the scan electrodes Y and the sustain electrodes Z during the set-up period, a difference between the amount of wall charges formed in the scan electrodes Y and the amount of wall charges formed in the sustain electrodes Z during the set-up period may be reduced. Accordingly, an erroneous discharge that may be generated between the scan electrodes Y and the sustain electrodes Z during an address period can be reduced, and the discharge efficiency between the scan electrodes Y and the address electrodes X can be improved.

For example, the V11 voltage may be identical to the V12 voltage, and the Vst1 voltage may be identical to the Vst2 voltage. Accordingly, the rising slopes of the first and second set-up signals may be identical. In this case, since a potential between the scan electrodes Y and the address electrodes X becomes identical to that between the sustain electrodes Z and the address electrodes X, the amount of wall charges formed in the scan electrodes Y and the sustain electrodes Z during the set-up period may almost become identical. Accordingly, even if a panel is driven under high temperature environment of 50 degrees Celsius or more, an erroneous address discharge depending on a shift in wall charges, etc. can be prevented.

If the width of the scan signal is 0.65 μs or less, an erroneous discharge may be generated because a sufficient time to generate an address discharge is not secured. Accordingly, in order to stably generate an address discharge, the width of the scan signal may be preferably 0.7 μs or more.

However, if the width of the scan signal exceeds 1.1 μs, a gap between the scan signals that are consecutively supplied is narrowed, so an erroneous address discharge may be generated due to the influence between neighboring scan electrode lines.

Accordingly, in order to secure a sufficient time to generate an address discharge and also prevent an erroneous address discharge by minimizing influence between neighboring scan electrode lines, the width of the scan signal may range from 0.7 μs to 1.1 μs.

Meanwhile, the embodiments according to the present invention, which have been described with reference to FIGS. 9 to 17 showing various embodiments of the waveforms supplied to the scan electrodes and the sustain electrodes during the reset period, are not limited to the combination with and/or modification of the embodiment of FIG. 5, but may be implemented in combination with the embodiment with respect to the driving waveforms of FIG. 23, in which the same reset signals are supplied to the entire scan electrodes during the reset period and signals similar to the reset signals are supplied to the entire sustain electrodes. Accordingly, it can be seen that a change in the voltage values, a difference in the slopes, etc. in FIGS. 9 to 17 may also be applied to the embodiment of FIG. 27, in which similar driving waveforms are supplied to the plurality of scan electrodes and sustain electrodes during the reset period.

While the invention has been shown and described with respect to the preferred embodiments, it will be understood by those skilled in the art that various changes and modifications may be made without departing from the spirit and scope of the invention as defined in the following claims.

What is claimed is:

1. A plasma display apparatus, comprising a plasma display panel having a plurality of scan electrodes and a sustain electrode formed in a front substrate, and drivers supplying driving signals to the plurality of electrodes,
wherein the plurality of scan electrodes is divided into two or more groups, each comprising first and second groups, and
in a reset period of at least one of a plurality of subfields constituting one frame, during a set-up period, voltages supplied to scan electrodes of at least one of the first and second groups gradually rise from a first voltage to a second voltage, and a voltage supplied to the sustain electrode gradually rises from a third voltage to a fourth voltage.

2. The plasma display apparatus of claim 1, wherein:
a number of scan electrode lines formed in the panel is 1080 or more, and
a width of a scan signal supplied to each of the scan electrodes ranges from 0.7 μs to 1.1 μs.

3. The plasma display apparatus of claim 1, wherein, during a set-down period of the reset period, voltages supplied to the scan electrodes gradually fall from a fifth voltage to a sixth voltage, and a voltage supplied to the sustain electrode gradually falls from a seventh voltage to an eighth voltage.

4. The plasma display apparatus of claim 3, wherein at least one of the fifth and seventh voltages is lower than the first and third voltages.

5. The plasma display apparatus of claim 3, wherein the eighth voltage is higher than the sixth voltage.

6. The plasma display apparatus of claim 3, wherein a voltage supplied to the sustain electrode during some of the set-down period is sustained to the eighth voltage.

7. The plasma display apparatus of claim 3, wherein, during the set-down period, a falling slope of the voltage supplied to the sustain electrode is gentler than a falling slope of the voltage supplied to each of the scan electrodes.

8. The plasma display apparatus of claim 3, wherein the seventh voltage is higher than the fifth voltage.

9. The plasma display apparatus of claim 3, wherein the eighth voltage is substantially the same as a ground voltage.

10. The plasma display apparatus of claim 3, wherein at least one of the sixth and eighth voltages is higher than a scan voltage.

11. The plasma display apparatus of claim 1, wherein rising slopes of the voltages supplied to the scan electrodes and the sustain electrode during the set-up period are substantially the same.

12. The plasma display apparatus of claim 1, wherein:
an address period sequentially includes a first scan period in which a scan signal is supplied to the first group, and a second scan period in which a scan signal is supplied to the second group, and
the address period further includes a period in which a second set-down signal that gradually falls is supplied between the first and second scan periods.

13. The plasma display apparatus of claim 12, wherein falling slopes of first set-down signals supplied to the first and second groups during the reset period are substantially the same as a falling slope of the second set-down signal.

14. The plasma display apparatus of claim 12, wherein lowest voltages of the first set-down signals supplied to the first and second groups during the reset period are higher than a lowest voltage of the second set-down signal.

15. The plasma display apparatus of claim 12, wherein a sustain bias voltage supplied to the sustain electrode during the period in which the second set-down signal is supplied is lower than a sustain bias voltage supplied to the sustain electrode during the first and second scan periods.

16. A plasma display apparatus, comprising a plasma display panel having a plurality of scan electrodes and sustain electrodes formed in a front substrate, and drivers supplying driving signals to the plurality of electrodes,
wherein the plurality of sustain electrodes is divided into two or more groups, each comprising first and second sustain groups, and the plurality of scan electrodes is divided into two or more groups, each comprising first and second scan groups; and
in a reset period of at least one of a plurality of subfields constituting one frame, while a voltage supplied to the first scan group gradually rises from a first voltage to a second voltage, a voltage supplied to the first sustain group gradually rises from a third voltage to a fourth voltage.

17. The plasma display apparatus of claim 16, wherein:
an address period sequentially includes first and second scan periods in which scan signals are supplied to the first and second scan groups, respectively, and
scan bias voltages supplied to the first and second scan groups in at least one of the first and second scan periods are different from each other.

18. The plasma display apparatus of claim 17, wherein, in a scan period of the first scan group, a scan bias voltage supplied to the second scan group is higher than the scan bias voltage supplied to the first scan group.

19. The plasma display apparatus of claim 17, wherein the scan bias voltage supplied to the second scan group during the first scan period is higher than the scan bias voltage supplied to the second scan group during the second scan period.

20. A plasma display apparatus, comprising a plasma display panel having a plurality of scan electrodes and sustain electrodes formed in a front substrate and a plurality of address electrodes formed in a rear substrate, and drivers supplying driving signals to the plurality of electrodes,
wherein a number of scan electrode lines formed in the panel is 1080 or more, and a width of a scan signal supplied to each of the scan electrodes is 0.7 μs to 1.1 μs, and
in a reset period of at least one of a plurality of subfields constituting one frame, during a set-up period, voltages supplied to the scan electrodes gradually rise from a first voltage to a second voltage, and voltages supplied to the sustain electrodes gradually rise from a third voltage to a fourth voltage.
